(19) United States
(12) Patent Application Publication
(10) Pub. No.: US 2026/0303002 A1
(43) Pub. Date: Oct. 1, 2026

(54) APPARATUS AND METHODS FOR MOVING SOLAR MODULES BY REUSABLE TRAY IN NATUREMOUNT APPLICATIONS

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/631,990

(22) Filed: Mar. 27, 2026

Related U.S. Application Data
(60) Provisional application No. 63/778,680, filed on Mar. 27, 2025.

(51) Int. Cl. H02S 20/20

(52) U.S. Cl. CPC H02S 20/20

(57) ABSTRACT

An apparatus includes a solar panel assembly. The solar panel assembly includes solar panel modules. Each solar panel module includes a solar panel and a frame. Each solar panel module is mechanically coupled to at least one other solar panel module. The apparatus also includes a tray. The tray is sized and configured to removably contact a portion of a perimeter of each solar panel module from at least a subset of the solar panel modules. The tray is configured to limit a flexure of the solar panel assembly when the solar panel assembly is in contact with the tray.

### CROSS-REFERENCE TO RELATED APPLICATION

This application claims priority to U.S. Provisional Patent Application No. 63/778,680, filed Mar. 27, 2025 and titled “Apparatus and Method for Moving Solar Modules by Reusable Tray in Naturemount Applications,” the entirety of which is incorporated by reference herein.

### TECHNICAL FIELD

The present disclosure relates generally to a reusable tray for solar modules.

### BACKGROUND

Solar panel assemblies can generate more electric power than solar panels alone. While some known systems can transport individual solar panels, challenges remain to transport solar panel assemblies without causing, for example, cracking, flexure, or twisting. Transportation difficulties can impede modular deployment of a solar panel assembly, for example, in different areas of a single environment and/or in different types of environments. Consequently, a need exists for an apparatus and method for moving solar panel assemblies.

### SUMMARY

In some embodiments, an apparatus includes a solar panel assembly. The solar panel assembly includes a plurality of solar panel modules. Each solar panel module from the plurality of solar panel modules includes a solar panel from a plurality of solar panels and a frame from a plurality of frames. Each solar panel module from the plurality of solar panel modules is mechanically coupled to at least one other solar panel module from the plurality of solar panel modules. The apparatus also includes a tray. The tray is sized and configured to removably contact a portion of a perimeter of each solar panel module from at least a subset of solar panel modules from the plurality of solar panel modules. The tray is configured to limit a flexure of the solar panel assembly when the solar panel assembly is in contact with the tray.

In some embodiments, a method includes removably attaching, at a first time, a tray to a first array of solar panel modules, thereby defining a first reenforced array of solar panel modules. The method also includes moving the first reenforced array of solar panel modules from an interior of a container to an exterior of the container. The method also includes removing the tray from the first reenforced array of solar panel modules after moving the first reenforced array of solar panel modules. The method also includes removably attaching, at a second time after the first time, the tray to a second solar panel module, thereby defining a second reenforced array of solar panel modules. The method also includes moving the second reenforced array of solar panel modules from the interior of the container to the exterior of the container. The method also includes removing the tray from the second reenforced array of solar panel modules after moving the second reenforced array of solar panel modules.

### BRIEF DESCRIPTION OF THE DRAWINGS

FIG. 1 depicts an example of solar panel modules on wheeled metal racks.

FIG. 2A depicts a side view of an example tray for moving a solar panel assembly, according to an embodiment.

FIG. 2B depicts a plan view of a system for moving a solar panel assembly with a reusable tray, according to another embodiment.

FIG. 2C depicts a cross-sectional side-view of a shipping container for transporting solar panel modules, according to an embodiment.

FIG. 3 depicts a perspective view of a landscape-landscape solar tent with a right angle, according to an embodiment.

FIG. 4 depicts a partial cross-sectional view of a solar tent with a coupler, according to an embodiment.

FIG. 5A depicts a plan view of a landscape-landscape solar tent, according to an embodiment.

FIG. 5B depicts a cross-sectional view of the landscape-landscape solar tent of FIG. 5A with a right angle.

FIG. 6 depicts a plan view of a portrait solar panel module and a landscape solar panel module, according to an embodiment.

FIG. 7 depicts a plan view of a portrait-landscape solar tent, according to an embodiment.

FIG. 8A depicts a cross-sectional view of the portrait-landscape solar tent of FIG. 7, with a right angle.

FIG. 8B depicts a cross-sectional view of a portrait-landscape solar tent of FIG. 7, with a 135 degree angle.

FIG. 9 is a diagram of an example microgrid system for microgrid metering and energy allocation, according to an embodiment.

FIG. 10 is a graph depicting an example power profile of a solar tent, according to an embodiment.

FIG. 11 is a flow diagram of a method for assembling a solar tent, according to an embodiment.

FIG. 12 is a flow diagram of a method for moving solar panel modules by a reusable tray, according to an embodiment.

FIG. 13 depicts a perspective view of an example solar tent with a coupler, according to an embodiment.

FIG. 14 depicts a perspective view of an example solar tent with a base-attached splay limiter, according to an embodiment.

FIG. 15 depicts a perspective view of an example solar tent with another base-attached splay limiter, according to another embodiment.

FIG. 16A depicts a perspective view of an example solar tent with ground-attached splay limiters, according to an embodiment

FIG. 16B depicts the ground-attached splay limiter of FIG. 16A, according to an embodiment.

### DETAILED DESCRIPTION

Some embodiments set forth herein can include one or more transportable solar microutility products (also referred to herein as “Firefly” products or systems), and, examples of Firefly implementations compatible with one or more embodiments of the present disclosure can be found in one or more of U.S. patent application Ser. No. 19/420,125, titled “Wind Deflector for Solar Arrays” and filed Dec. 15, 2025; U.S. Pat. No. 11,431,169, titled “Systems and methods for microgrid metering and energy allocation” and issued Aug. 30, 2022; U.S. Pat. No. 11,489,337, titled “Systems and Methods for Microutility Metering and Energy Allocation” and issued Nov. 1, 2022; U.S. Pat. No. 12,081,021, titled “Systems and methods for microgrid metering and energy allocation” and issued Sep. 3, 2024; U.S. Pat. No. 11,764,577, titled “Systems and Methods for a Mobile Micro Utility” and issued on Sep. 19, 2023; and U.S. Pat. No. 11,824,357, titled “Systems and Methods for a Mobile Micro Utility” and issued on Nov. 21, 2023, the contents of each of which are incorporated by reference herein in their entireties, for all purposes.

In one or more embodiments, a Firefly system includes a NatureMount™ feature(s). As used herein, the term “NatureMount™” can refer, by way of example, to a solar module mounting structure that reduces or minimizes a grading of a terrain, a levelling of a terrain, and/or an amount/presence of a foundation in connection with the placement of the solar module(s) on natural land (e.g., earth). Stated another way, NatureMount can refer to a system that facilitates placement of solar module(s) on natural land with a reduced amount of preparation of the natural land location, as contrasted with known systems/methods.

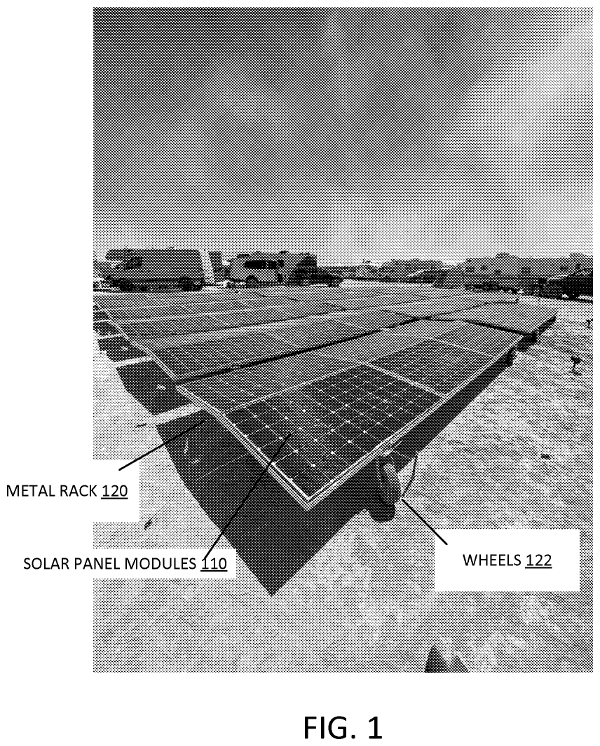

In a first example embodiment of Firefly, a module-frame rack and tray are configured to supplement (or replace), for example, a transportable solar microutility product (e.g., shown in FIG. 1) that includes metal racks for holding solar panel modules in place. The metal racks of FIG. 1 can also include wheels for transporting the solar panel modules during, for example, deployment and take-down. The module-frame rack and tray concept described herein can include a rack having fewer components and that is lighter weight relative to the transportable solar microutility product of FIG. 1 and/or can include a separate “tray” that can be configured to transport the rack during, for example, deployment and take-down. In some embodiments, the module-frame rack can be and/or include a rack that includes solar module frames that are affixed to each other so that the rack is (e.g., almost) entirely composed of the solar module assemblies themselves. Such a rack can have limited bending and torsional stiffness such that, if the racks were lifted at their rack end portions (e.g., for transportation), the applied forces can result in bending and cracking of the solar panels in the solar panel modules. Therefore, a “tray” can be configured to provide functionality of an additional support during, for example, deployment and/or take-down. The rack can be removably coupled to the tray. For example, the rack can be placed on (or affixed to) the tray during a first time period and removed from (or unaffixed to) the tray during a second time period different from the first time period so that the tray can support other racks.

In a second example embodiment of Firefly, a module-frame rack and tray includes a module-frame rack with a 90-degree angle. The module-frame rack with a 90-degree angle can be an implementation of the module-frame rack that includes a first set of solar module frames that is coupled (e.g., affixed, etc.) to a second set of solar modules frames such that a plane of the first set of solar module frames has a substantially 90-degree angle (or be substantially orthogonal) relative to a plane of the second set of solar module frames. The 90-degree module-frame rack implementation can enable solar module frames to be joined flat-surface-to-flat-surface without additional parts (e.g., without a coupler). In some embodiments, a more generic implementation of the modular frame rack can include a coupler configured to be placed and/or positioned between a frame of the first set of solar panel module(s) and a frame of the second set of solar panel module(s). For example, the coupler can be and/or include a metal angle (e.g., a mass produced metal angular structure, such as a structural steel angle, or other standard such as an aluminum angle, a metallic bar with faces machined to an angle, an extruded aluminum part with a predefined angle, etc.).

In a third example embodiment of Firefly, a solar module rack and/or tray includes a portrait and/or landscape “tent.” In the transportable solar microutility product of FIG. 1, racks can be configured to hold solar panel modules in a relatively flat, inverted “V” configuration to facilitate, for example, water runoff. A variation of the flat, inverted “V” configuration, in accordance with some embodiments, steepens the “V” and makes the “V” asymmetric, with the east-tilted solar panel modules being tilted at a relatively steep angle and the west-tilted solar panel modules being tilted at a relatively flatter/shallower angle. In embodiments where the rack results from (or is defined by) coupling (e.g., affixing, etc.) the frames of the solar panel modules to each other, the tilt and asymmetry of the portrait-landscape tent can be achieved by orientating the east-facing solar panel modules in a landscape orientation and orienting the west-facing solar panel modules in a portrait orientation (or vice versa), as described in further detail herein.

In addition to the foregoing example implementation details, the present disclosure also includes a concept for incorporating additional energy-consuming services that are under common control with the energy generation and energy storage subsystems of one or more Firefly embodiments. Such services can deliver value to the community served by the one or more Firefly embodiments. By being under common control, loads can serve as controllable electrical loads, helping to reduce the need for relatively expensive battery energy storage capacity relative to similar services operated under third-party control.

FIG. 1 depicts solar panel modules on wheeled metal racks. FIG. 1 includes solar panel modules 110 and metal rack 120, which collectively define a transportable solar microutility product that does not include the module-frame rack described herein. Metal rack 120 includes wheels 122. In FIG. 1, the solar panel modules 110 can be fixedly coupled to (e.g., clamped into, etc.) metal rack 120 so that metal rack 120 holds the solar panel modules 110 in place (e.g., in a specified configuration/orientation). Metal rack 120 can be a wheeled support for supporting the solar panel modules 110 and for transporting the solar panel modules 110 during, for example, deployment and take-down. Metal rack 120 can, however, include additional materials relative to some embodiments herein and can involve significant manufacturing effort. For example, many metal parts are cut and welded to each other, and the flat “V” shape involves machining of the frame parts to a specific angle.

Solar panels are typically shipped as an assembly (also referred to herein as a module) that includes a lightweight frame. The frame can help to prevent bending of the solar panel module during handling, which is desirable because the solar panel associated with the solar panel module can otherwise be easily damaged by bending. The frame can also provide a structure that can be clamped when mounting the solar panel module, which is desirable because clamping onto the solar panel itself can crack or otherwise damage the solar panel.

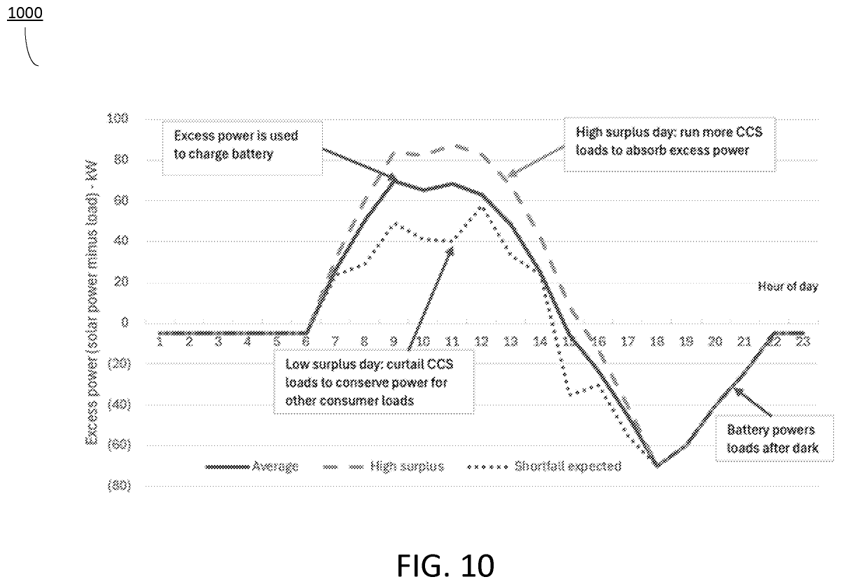

In FIG. 1, the metal rack 120 is configured to hold the solar panels in a flat, inverted “V” configuration for water runoff. The inverted “V” shape is not solely useful for running off water, however. For example, when the axis of the “V” is oriented north-south, the east-tilted solar panel modules from solar panel modules 110 can generate more power in the earlier morning than that generated by solar panel modules that are aimed directly upward, and the west-tilted solar panel modules from solar panel modules 110 can generate more power in the afternoon than that generated by solar panel modules that are aimed directly upward. During the center part of the day (e.g., around noon/midday), both the east-tilted solar panel modules and the west-tilted solar panel modules can produce somewhat less power than that generated by solar panel modules that are aimed directly upward. The result is that a solar rack with an inverted “V” configuration can produce a flatter power profile throughout the day than that of a flat solar rack, although total energy production of the solar rack with the inverted “V” configuration can also be slightly lower. The flatter power profile, with the lower peak value, can improve the match between power production and typical electrical load profiles, reducing reliance on (costly) energy storage capacity. An example power profile of a solar rack with an inverted “V” configuration is shown and described with respect to FIG. 10.

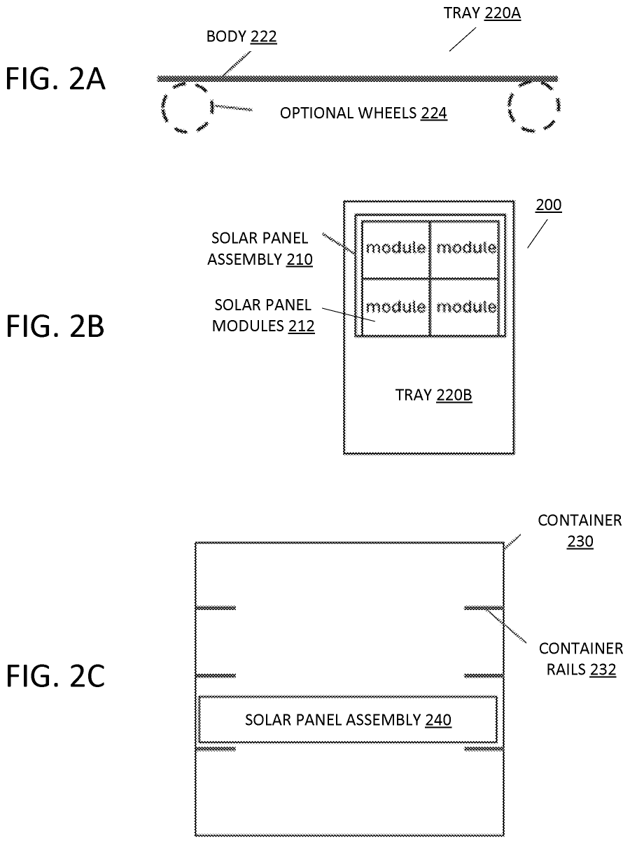

FIG. 2A depicts a side view of an example tray 220A for moving a solar panel assembly, according to an embodiment. Tray 220A can be configured to transport a solar panel module (not shown in FIG. 2A), multiple solar panel modules (not shown in FIG. 2A), and/or a solar panel assembly (not shown in FIG. 2A) that includes two or more solar panel modules between two locations. For example, tray 220A can move solar panel module(s) between a shipping container (not shown in FIG. 2A) and a deployment site (not shown in FIG. 2A) for the solar panel module(s). Instead, or in addition, tray 220A can move solar panel module(s) between a first deployment site (not shown in FIG. 2A) and a second deployment site (not shown in FIG. 2A). Tray 220A can be reusable. Stated similarly, tray 220A can be configured to removably contact a first set of solar panel module(s) at a first time and removably contact a second set of solar panel module(s) at a second time different from the first time, for purposes of, for example, transportation, storage, support, and/or the like. Tray 220A includes body 222 and can optionally include wheels 224 rotatably coupled to body 222.

Body 222 can be configured to support a solar panel module (not shown in FIG. 2A), multiple solar panel modules (not shown in FIG. 2A), and/or a solar panel assembly (not shown in FIG. 2A) that includes two or more solar panel modules. Body 222 can be sized and/or shaped to cause at least a portion of each solar panel module from one or more solar panel module(s) to contact body 222, when the one or more solar panel module(s) are supported by body 222. As shown, body 222 can be continuous and substantially flat. In some embodiments, however, a body of a tray can be discontinuous with two or more different sized portions that are each substantially flat. For example, a first portion of a tray body can have a height (relative to ground) that is different from (e.g., less than, greater than) a height of a second portion of a tray body. In some implementations, the body 222 can be a solid sheet/panel of material, while in other implementations the body 222 can have a structure that is perforated, mesh, porous, etc. Alternatively or in addition, while shown in FIG. 2B as having a rectangular shape (i.e., an outer perimeter thereof is rectangular), in other implementations the tray 220B can have a square, polygonal, or other suitable shape. Alternatively or in addition, in some implementations, the body 222 includes a plurality of rollers or wheels embedded therein and configured to contact an underside of a solar panel assembly, for example to facilitate the placement of the solar panel assembly 210 onto the tray 220B and/or the removal/withdrawal of the solar panel assembly 210 from the tray 220B. Alternatively or in addition, in some implementations, the tray 220A includes a lift mechanism or jacking mechanism such that a height of the body 222 (e.g., relative to wheels 224, if included, or relative to a horizonal support surface on which the tray 220A is positioned) can be adjusted. Such a lift/jack mechanism can, for example, facilitate the insertion of the solar panel assembly 240 into container 230, on a selected pair of container rails 232 at a selected/desired height.

In some implementations, body 222 can be configured to add a rigidity and/or to limit (or prevent) a flexure, a twisting, and/or a cracking of a solar panel assembly when the solar panel assembly is in contact with tray 220A. For example, body 222 can include a rigid material with a sufficient strength, and of sufficient size and shape, to add a rigidity to one or more solar panel module(s) and/or limit (or prevent) a flexure, a twisting, and/or a cracking of one or more solar panel module(s), when at least a portion of each solar panel module from the one or more solar panel module(s) are in contact with body 222.

In some implementations, a solar panel module can contact body 222 at predefined portions of body 222. For example, body 222 can include recesses (or grooves, divots, clamps) that can limit (or prevent) a flexure, a twisting, and/or a cracking of a solar panel assembly when contact portions of the solar panel assembly are inserted into the recesses (or grooves, divots, clamps). As another example, body 222 can include a friction coating that can limit (or prevent) a slipping, a twisting, and/or a cracking of a solar panel assembly when portions of the solar panel assembly contact body 222.

FIG. 2B depicts a plan view of a system 200 for moving a solar panel assembly with a reusable tray, according to an embodiment. System 200 includes tray 220B and solar panel assembly 210. Tray 220B can be structurally and/or functionally similar to tray 220A of FIG. 2A. Solar panel assembly 210 can be and/or include two or more solar panel modules that are coupled together. For example, solar panel assembly 210 can be and/or include an “inverted V” solar tent, a symmetric solar tent, an asymmetric solar tent, a landscape-landscape solar tent, a landscape-portrait solar tent, and/or other types of solar panel assemblies described herein. Tray 220B can be sized and configured to removably contact at least a portion of a perimeter of each solar panel module 212 from at least a subset of the solar panel modules 212 in solar panel assembly 210. For example, when solar panel modules 212 are arranged and/or disposed in a solar tent configuration, a portion (e.g., a sidewall, a corner, etc.) of a frame of a first solar panel module can contact tray 220B at a first position on a tray body, and a portion (e.g., a sidewall, a corner, etc.) of a frame of a second solar panel module can contact tray 220B at a second position on a tray body that is different from the first position of the tray body. Tray 220B can be configured to support and transport solar panel assembly 210, for example, between a shipping container (not shown in FIG. 2B) and a deployment site for solar panel assembly 210, between two different deployment sites, and/or the like.

Solar panel assembly 210 includes solar panel modules 212. In some implementations, solar panel assembly 210 can be and/or include a module-frame rack. A module frame rack can be, for example, solar panel module frames that are coupled together to provide functionality of a rack (e.g., metal rack 120 of FIG. 1 or other racks, not shown in FIG. 2B) as a support for solar panel modules 212. That is, the solar panel module frames can be affixed to each other directly, or almost so, with minimal or no other parts being used. Such a configuration can be achieved by, for example, disposing/arranging solar panel modules 212 in a flat (or tilted) array and affixing the frames of the solar panel modules 212 together “edge-to-edge” such that a sidewall of a first frame of a first set of solar panel modules from solar panel modules 212 abuts a second frame of a second set of solar panel modules from solar panel modules 212. Affixing can involve, for example, clamps, nuts and bolts, rivets, hinges, welding and/or bonding. For example, solar panel module frames that include aluminum can be readily bonded with other solar planal module frames.

A module frame rack can be configured (e.g., by the module manufacturer) to be sufficiently stiff to limit (or prevent) flexure, twisting, and/or cracking of the solar panels from solar panel modules 212 during, for example, handling. When solar panel module frames are affixed to each other to define a larger rack (e.g., a rack associated with solar panel assembly 210), however, and such a rack is handled (e.g., for deployment or take-down), the additional length and weight can create a risk of causing flexing and cracking of the solar panels. The tray 220B can be configured to provide functionality as an additional structural support( ) for the rack associated with solar panel assembly 210 while the solar panel assembly 210 is being relocated, for example to deploy the solar panel assembly 210 from a shipping container (e.g., a delivery enclosure; not shown in FIG. 2B) to an installation (or deployment) site, or to return the solar panel assembly 210 to a shipping container (e.g., the delivery enclosure; not shown in FIG. 2B). The tray 220B can be sufficiently stiff to limit (or prevent) flexure, cracking, bending and/or twisting of the rack associated with solar panel assembly 210 while both the tray 220B and solar panel assembly 210 are collectively being transported, for example by carrying (involving multiple people) or by using optional wheels (e.g., wheels 224 of FIG. 2A) attached to the tray 220B or by machinery such as a forklift. Once solar panel assembly 210 has been moved and removed from the tray 220B, the tray 220B can be configured to transport another solar panel assembly or other solar panel module(s) (not shown in FIG. 2B).

FIG. 2C depicts a diagram of a shipping container for transporting solar panel modules, according to an embodiment. Container 230 can be configured to removably, mechanically support, removably store and/or removably transport solar panel assembly 240. Container 230 can include container rails 232. Container rails 232 can include any appropriate number (e.g., three) of pairs of rails (e.g., that will fit inside the container 230), where each pair of rails includes a first rail portion coupled to a first side of container 230 and a second rail portion coupled to a second side of container 230 that is opposite to and facing the first side of container 230. Each pair from container rails 232 can be configured to support and position a rack that removably, mechanically supports solar panel assembly 240. For example, a frame of a solar panel module from solar panel assembly 240 can be slidably inserted into container 230 via a pair of rails from container rails 232, removably positioned onto the pair of rails, and slidably removed from container 230. In some implementations, container rails 232 can be configured to provide a surface for coupler(s) (not shown) to couple solar panel assembly 240 to container rails 232.

In some implementations, the embodiments of FIGS. 2A-2C can form a transportable solar microutility system, for example as described in U.S. provisional patent application No. 63/778,704, filed Mar. 27, 2025 and titled “Module-Frame Rack for Naturemount Applications,” or as described in U.S. patent application Ser. No. 19/450,338, filed Jan. 15, 2026 and titled “Wind Deflector for Solar Arrays,” the entire contents of each of which are incorporated by reference herein. For example, the solar panel assembly 240 of FIG. 2C can be removed from container 230 onto tray 220A for transportation to a deployment site, and/or the tray 220B can transport solar panel assembly 210 to container 230.

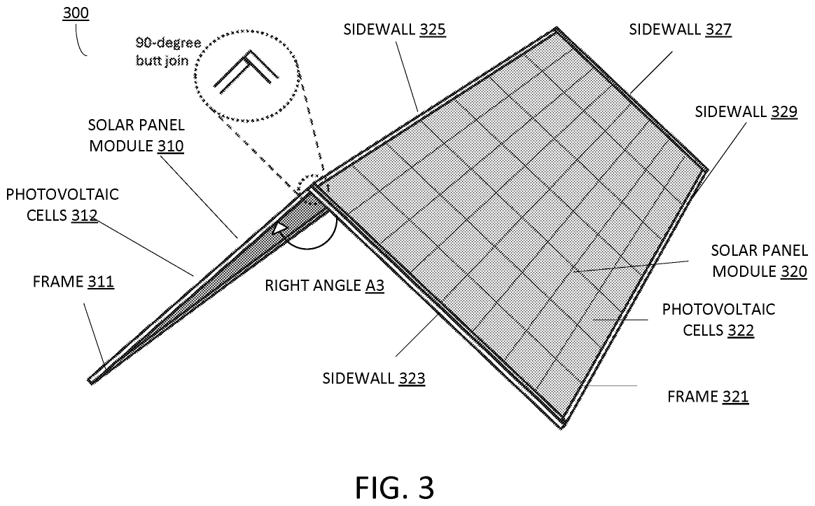

FIG. 3 depicts a perspective view of a landscape-landscape solar tent 300 (or simply, solar tent 300) with a right (i.e., 90-degree) angle A3, according to an embodiment. FIG. 3 depicts an implementation of the module-frame rack, in which solar tent 300 has an inverted “V” shape. In some implementations, the inverted “V” shape of solar tent 300 can be created by affixing the solar panel frames (i.e., frame 311 and frame 321) to each other at a 90-degree angle. The solar panel frames can, for example, be joined flat-surface-to-flat-surface (e.g., in a 90-degree or substantially 90-degree “butt join,” as shown in FIG. 3) without any additional parts. Accordingly, solar tent 300 includes solar panel module 310 and solar panel module 320 and, in some implementations, may not include components other than solar panel module 310 and solar panel module 320, such as a coupler. Solar panel module 310 includes frame 311 and photovoltaic cells 312. Photovoltaic cells 312 can define a solar panel associated with solar panel module 310. Frame 311 can be coupled (e.g., mechanically coupled, adhesively coupled, etc.) to photovoltaic cells 312. Solar panel module 320 includes frame 321 and photovoltaic cells 322. Photovoltaic cells 322 can define a solar panel associated with solar panel module 320. Frame 321 can be coupled (e.g., mechanically coupled, adhesively coupled, etc.) to photovoltaic cells 322.

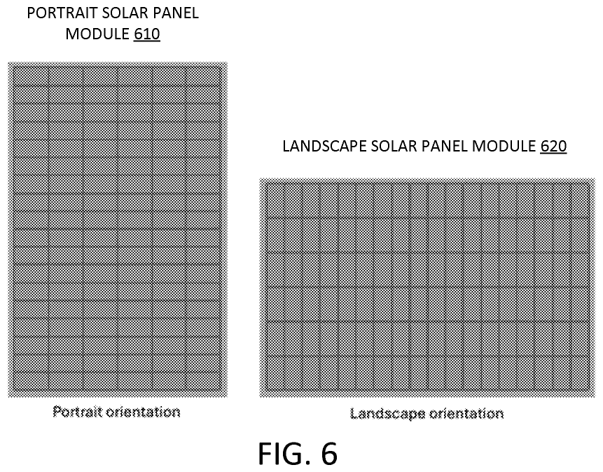

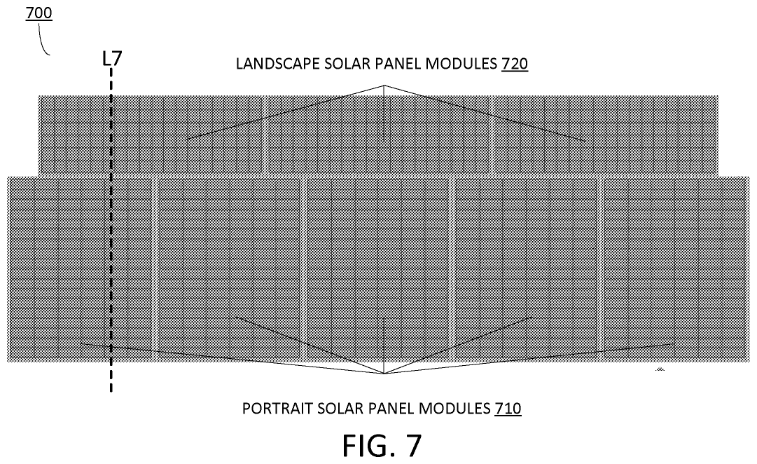

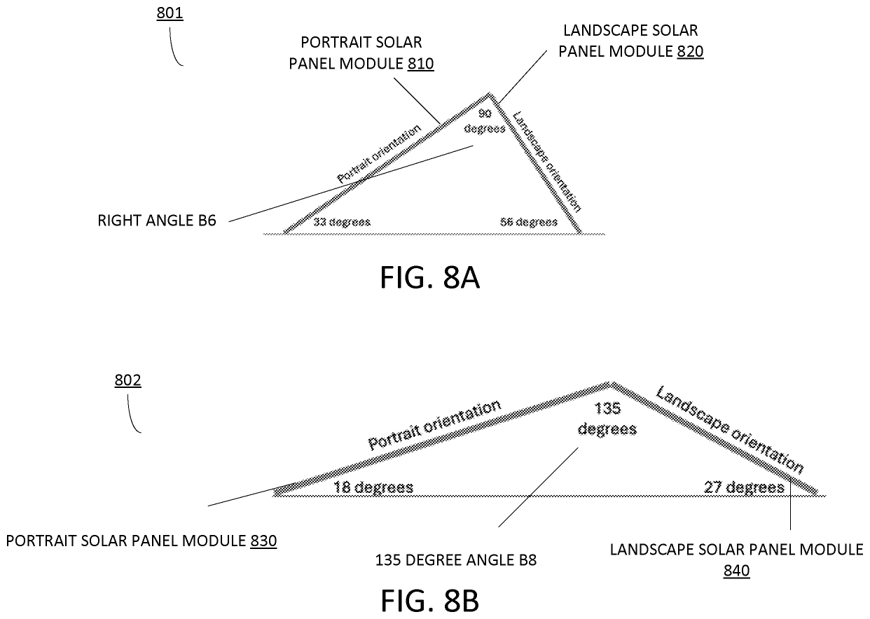

Frame 321 and frame 311 can each include, for example, aluminum (e.g., anodized aluminum, an aluminum alloy(s), etc.), steel, a composite material(s), and/or any other suitable material(s). Frame 321 includes sidewall 323, sidewall 325, sidewall 327, and sidewall 329. Although the perspective view of FIG. 3 does not depict in detail the photovoltaic cells of solar panel module 310 or the sidewalls of frame 311, it is to be understood that solar panel module 310 includes such components. Each of sidewall 323, sidewall 325, sidewall 327, and sidewall 329 can be a different (i.e., no more than partially overlapping) portion of frame 321. As depicted, sidewall 323 can be a portion of frame 321 that is opposite and substantially parallel to sidewall 327 and that is substantially orthogonal to each of sidewall 325 and sidewall 329. Similarly, sidewall 325 can be a portion of frame 321 that is opposite and substantially parallel to sidewall 329 and that is substantially orthogonal to each of sidewall 323 and sidewall 327. As depicted, each of sidewall 325 and sidewall 329 can be longer than each of sidewall 323 and sidewall 327, such that solar panel module 320 is understood to be in a “landscape” orientation relative to remaining portions of solar tent 300. Solar panel module 310, although partially obscured by the perspective view of FIG. 3, is also in a “landscape” orientation relative to remaining portions of solar tent 300, such that solar panel module 310 and solar panel module 320 define a landscape-landscape (or symmetric) solar tent (i.e., landscape-landscape solar tent 300). In some implementations, however, a sidewall with a same relative position as sidewall 325 can be shorter than a sidewall with a same relative position as sidewall 323 and/or a sidewall with a same relative position as sidewall 327, such that a solar panel module is understood to be in a “portrait” orientation relative to remaining components of such a solar tent. For example, FIG. 6 shows a solar panel module in such a “portrait” orientation. In some embodiments, at least one solar panel module of a solar tent can have an orientation different from an orientation of at least one remaining solar panel module of a solar tent. For example, FIGS. 7 and 8A-8B each show a different solar tent that each include at least one solar panel module in a landscape orientation and at least one solar panel module in a portrait orientation, to define a portrait-landscape (or asymmetric) solar tent.

Solar panel module 320 can be fixedly attached to solar panel module 310 so that sidewall 325 abuts at least a portion of a sidewall (e.g., a sidewall that is partially obscured by the perspective view of FIG. 3) of solar panel module 320 such that a plane of solar panel module 320 is substantially orthogonal to a plane of solar panel module 310. Stated similarly, solar panel module 310 can be fixedly attached to solar panel module 320 such that a plane of solar panel module 320 and a plane of solar panel module 310 form (or define) right angle A3. Solar panel module 310 can be fixedly attached to solar panel module 320 via, for example, an abutment, an adhesive(s), a laminate(s), a fastener(s), epoxy, a brazed joint(s), a clamp(s), nuts, bolts, rivets, hinges, welds, a metallic bond, and/or the like.

In some implementations, solar panel module 310 can be attached to solar panel module 320 via a fastener such that when solar panel module 310 is rotated relative to solar panel module 320, solar panel module 310 and solar panel module 320 locks into place in a configuration having right angle A3 to define a type of clamshell configuration of solar tent 300, such as the clamshell configurations described in U.S. patent application Ser. No. 19/240,125, filed Dec. 15, 2025 and titled “Naturemount Solar Arrays,” the entirety of which is incorporated by reference herein. In some implementations, solar panel module 310 can be hingedly attached (e.g., via a hinge) to solar panel module 320 to define another type of clamshell configuration of solar tent 300. In some implementations, solar panel module 320 can be fixedly attached to solar panel module 310 via an adhesive extending along at least a portion (e.g., an eighth, a quarter, a half, etc.) of a length of sidewall 325. In some implementations, solar panel module 320 can be fixedly attached to solar panel module 310 only via an adhesive. In some implementations, solar panel module 320 can be fixedly attached to solar panel module 310 only via a fastener. In some implementations, solar panel module 320 can be fixedly attached to solar panel module 310 only via a laminate.

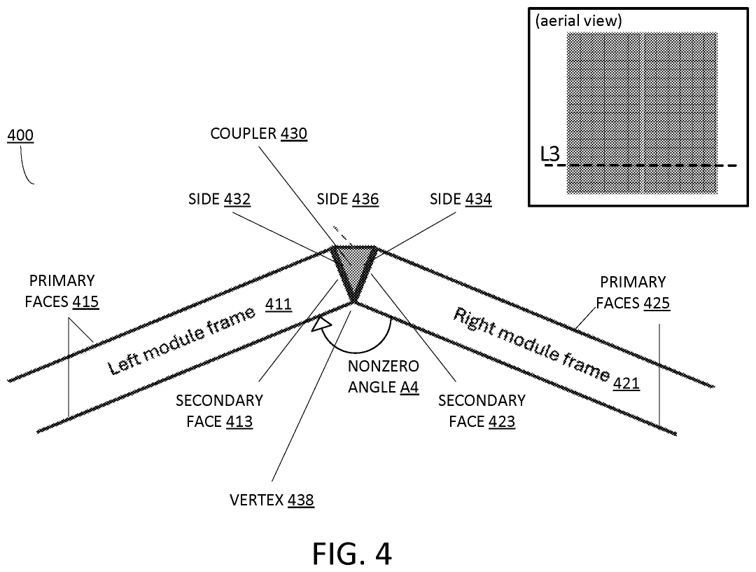

In some embodiments, a solar panel module can be fixedly attached to a second solar panel module such that a nonzero angle therebetween is different from 90-degrees, for example about 45 degrees, about 135 degrees, etc. In some embodiments, a more general implementation can involve affixing solar panel frames, not directly to each other, but to a coupler placed between them. For example, FIG. 4 shows such a configuration for a solar tent.

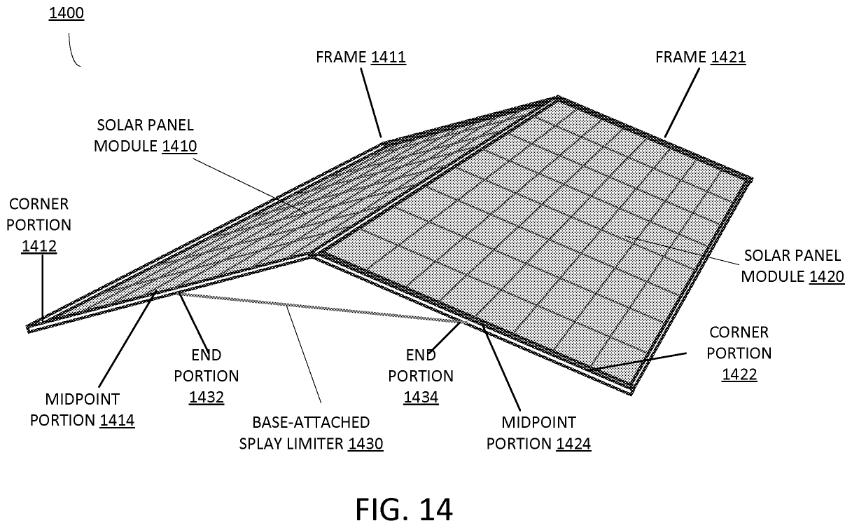

In some implementations, solar tent 300 can be in contact with a tray (e.g., tray 220A of FIG. 2A, tray 220B of FIG. 2B; not shown in FIG. 3), for example, along portions of a perimeter of solar tent 300 such as sidewall 329 of solar panel module 320 and a similar sidewall of solar panel module 310. In some instances, solar tent 300 can be stored on the tray. In some instances, solar tent 300 can be transported by the tray between locations. During transport, the solar tent 300 may be in the fully deployed inverted-V configuration shown in FIG. 3, or in a partially flattened configuration (e.g., between a flat configuration and the right angle configuration of FIG. 3), or in a flat configuration (e.g., folded, collapsed, etc.). For example, in a fully deployed inverted-V configuration, the solar tent 300 can receive the tray to cause a bottom portion (e.g., sidewall 329 of solar panel module 320) of solar panel module 320 and/or a bottom portion of solar panel module 310 to at least partially overhang the tray edges, and in some implementations a splay limiter (e.g., shown in FIGS. 14-16) can be attached under the tray body. Furthermore, when the solar tent 300 has been positioned, the tray can be “lowered” and slidably removable from under the tent body. Solar tent 300 can be transported between a shipping container (e.g., container 230 of FIG. 2C) and an installation site by the tray. Instead, or in addition, solar tent 300 can be transported between a first area of an environment and a second area of an environment by the tray. The tray can enable the solar tent 300 to be transported to and/or between multi-terrain environments such as, for example, ungraded ground, rocky landscape, deserts, rooftops, and/or the like.

In some embodiments, when a tray is configured to transport the solar tent 300 in the fully deployed inverted V configuration (e.g., as shown in FIG. 3), the tray includes, at least in part, a surface having a shape (e.g., at least a segment of an inverted V) that is complementary or parallel to a portion of the solar tent to which the tray is coupled during use (e.g., during transport of the solar tent 300).

FIG. 4 depicts a partial cross-sectional view of a solar tent 400 with a coupler, according to an embodiment. The partial cross-sectional view is taken at the cross-section line L3 shown (from an aerial perspective) at the inset of FIG. 4. Solar tent 400 includes left module frame 411 (e.g., structurally and/or functionally similar to frame 311 of FIG. 3), right module frame 421 (e.g., structurally and/or functionally similar to frame 321 of FIG. 3), and coupler 430. Coupler 430 can be disposed between left module frame 411 and right module frame 421 to form solar tent 400 with nonzero angle A4.

Although not depicted in detail in the partial cross-sectional view of FIG. 4, it is to be understood that left module frame 411 is included with a first solar panel module (e.g., solar panel module 310 of FIG. 3) that has primary faces 415 and secondary face 413 and that right module frame 421 is included with a second solar panel module (e.g., solar panel module 320 of FIG. 3) that has primary faces 425 and secondary face 423. Primary faces 415 can include an active solar surface of the solar panel module associated with left module frame 411, and an inactive solar surface of the solar panel module associated with left module frame 411. For example, the active solar surface of primary faces 415 can include photovoltaic cells (e.g., photovoltaic cells 312 of FIG. 3). Similarly, primary faces 425 can include an active solar surface of the solar panel module associated with right module frame 421, and an inactive solar surface of the solar panel module associated with right module frame 421. For example, the active solar surface of primary faces 425 can include photovoltaic cells (e.g., photovoltaic cells 322 of FIG. 3). The inactive solar surface of primary faces 415 can be opposite and substantially parallel to the active solar surface of primary faces 415. Similarly, the inactive solar surface of primary faces 425 can be opposite and substantially parallel to the active solar surface of primary faces 425. Secondary face 413 can be a portion of left module frame 411 that is smaller than and substantially orthogonal to primary faces 415. In some implementations, secondary face 413 can be structurally and/or functionally similar to a sidewall of solar panel module 310 of FIG. 3. Similarly, secondary face 423 can be a portion of right module frame 421 that is smaller than and substantially orthogonal to primary faces 425. In some implementations, secondary face 423 can be structurally and/or functionally similar to sidewall 325 of solar panel module 320 of FIG. 3.

Coupler 430 can be and/or include any material that is sufficiently strong to mechanically support left module frame 411 and right module frame 421 such that left module frame 411 and right module frame 421 form solar tent 400 with nonzero angle A4. For example, coupler 430 can be and/or include a metal structure that defines an angle between two surfaces such as a standard mass-produced metal angle or a purpose-made angle (e.g., an aluminum extrusion). Coupler 430 has a triangular cross-section with three vertices (i.e., angular points) defined by side 434, side 434, and side 436. Each of side 432, side 434, and side 436 can be a different surface of coupler 430. As shown, side 436 is disposed between side 432 and side 434. Vertex 438 is the angular point (or the set of angular points) that connects side 432 and side 434. A first included angle defined by side 432, vertex 438, and side 434 is about 45 degrees. A second vertex exists between side 432 and side 436 (defining a second included angle of about 67.5 degrees) and a third vertex exists between side 434 and side 436 (defining a third included angle of about 67.5 degrees). Accordingly, the triangular cross-section of coupler 430 is a triangular acute isosceles that represents a cross-section of the coupler 430.

In some embodiments, a coupler can have a cross-section shape with included angles different from those of coupler 430 and from a range of included angles no less than about 0 degrees and no more than about 180 degrees. For example, a coupler can have a triangular acute cross-section with three included angles, each about 60 degrees. Instead, a coupler can have a triangular scalene cross-section with three included angles, each of a different measure relative to the remaining included angles. Instead, a coupler can have a triangular isosceles cross-section with three included angles, two included angles being about 45 degrees and the remaining included angle being about 90 degrees. In some implementations, a coupler can have a cross-section shape different than a triangular cross-section, such as polygonal, oval, ellipse shaped, hexagonal, rectangular, circular, symmetric, asymmetric, regular, irregular, and/or the like. In some implementations, a coupler can have an included angle of about 10 degrees, about 20 degrees, about 30 degrees, about 35 degrees, about 40 degrees, about 45 degrees, about 50 degrees, about 55 degrees, about 60 degrees, about 70 degrees, about 75 degrees, about 90 degrees, about 120 degrees, about 135 degrees, about 140 degrees, about 145 degrees, about 150 degrees, about 160 degrees, about 170 degrees, and/or another included angle from the range of included angles.

Coupler 430 can be affixed to left module frame 411 and to right module frame 421 such that nonzero angle A4 exists between a plane of a solar panel module associated with left module frame 411 and a solar panel module associated with right module frame 421. Side 432 can be disposed between left module frame 411 (e.g., secondary face 413) and remaining portions of coupler 430. As shown, side 432 and vertex 438 each contact secondary face 413, where side 432 can be affixed to secondary face 413. Side 434 can be disposed between right module frame 421 (e.g., secondary face 423) and remaining portions of coupler 430. As shown, side 434 and vertex 438 each contact secondary face 423, where side 434 can be affixed to secondary face 423. The acute isosceles triangular cross-section of coupler causes nonzero angle A4 of solar tent 400 to be about 135 degrees. In some implementations, however, a solar tent can be configured to have a predefined angle other than about 135degrees. For example, a coupler can cause a solar tent to have a predefined angle from a range of predefined angles that is no less than about 0 degrees and no more than about 180 degrees. In some embodiments, a coupler can cause a solar tent to have a predefined angle of about 10 degrees, about 20 degrees, about 30 degrees, about 45 degrees, about 60 degrees, about 75 degrees, about 90 degrees, about 120 degrees, about 135 degrees, about 140 degrees, about 145 degrees, about 150 degrees, about 160 degrees, about 170 degrees, and/or another predefined angle from the range of predefined angles.

In some embodiments, a first side of a coupler can be configured to be affixed to a primary face of a first solar panel module, and a second side of a coupler can be configured to be affixed to a secondary face of a second solar panel module. For example, a coupler side with a same relative position as side 432 can be affixed to a first solar panel module primary face with a same relative position as secondary face 413, and a coupler side with a same relative position as side 436 can be affixed to a second solar panel module primary face with a same relative position as the inactive solar surface of primary faces 425 (or vice versa). In some embodiments, a vertex of a coupler can be configured to contact a primary face of a first solar panel module and to contact a secondary face of a second solar panel module. In the previous example, a vertex with a same relative position as the vertex between side 432 and side 436 can contact each of the first solar panel module secondary face and the second solar panel module primary face. Such configurations can extend to couplers with cross-section shapes different from that of coupler 430.

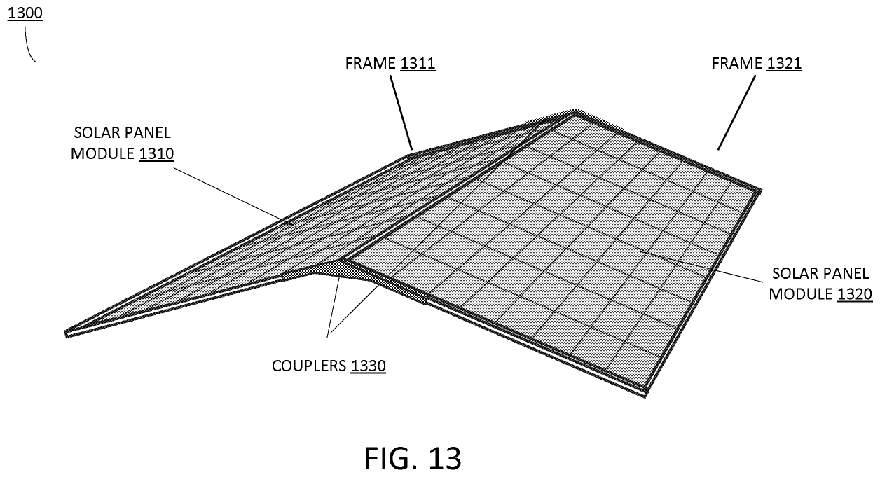

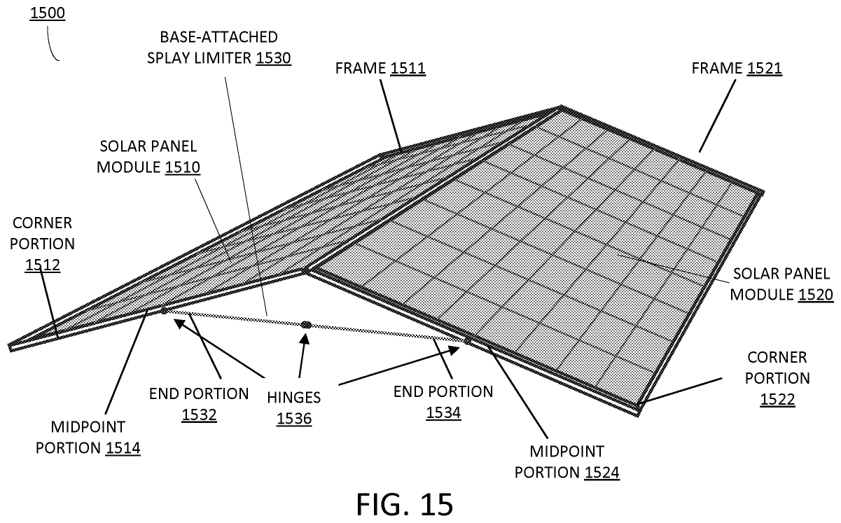

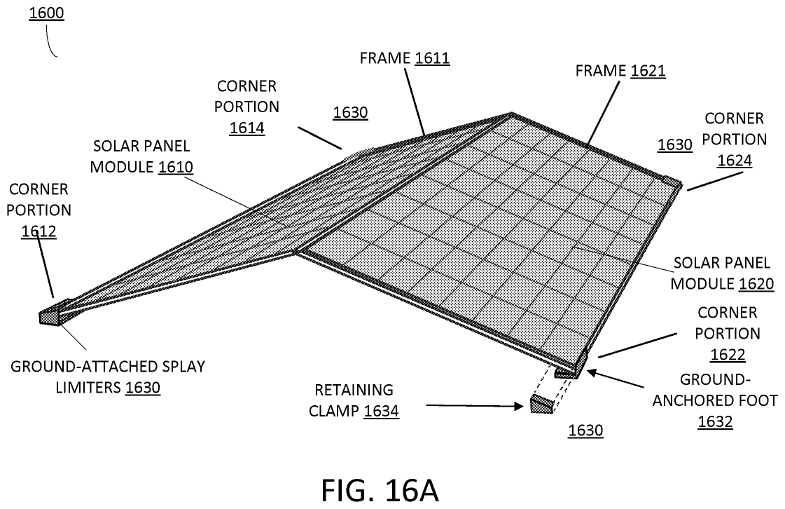

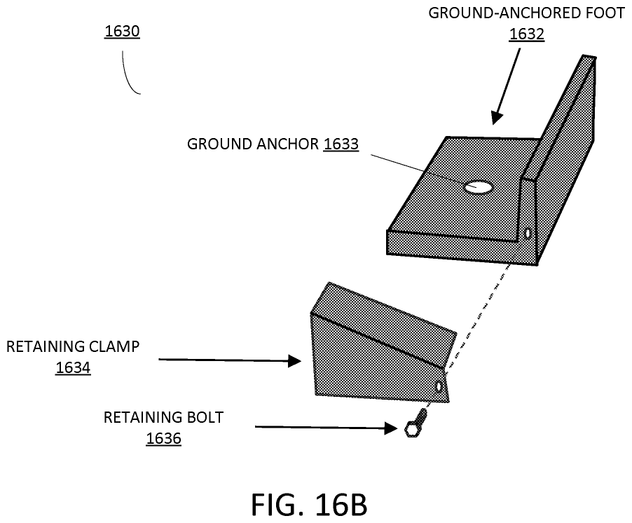

In some implementations, solar tent 400 can include one or more other types of couplers, for example, the couplers 1330 of FIG. 13. In some implementations, solar tent 400 can include one or more splay limiters, for example, the base-attached splay limiter 1430 of FIG. 14, the base-attached splay limiter 1530 of FIG. 15 and/or the ground-attached splay limiter 1630 of FIGS. 16A-16B.

In some implementations, solar tent 400 can be in contact with a tray (e.g., tray 220A of FIG. 2A, tray 220B of FIG. 2B; not shown in FIG. 3), for example, along portions of a perimeter of solar tent 400. In some instances, solar tent 400 can be stored on the tray. In some instances, solar tent 400 can be transported by the tray between locations. For example, solar tent 400 can be transported between a shipping container (e.g., container 230 of FIG. 2C) and an installation site by the tray. Instead, or in addition, solar tent 400 can be transported between a first area of an environment and a second area of an environment by the tray. During transport, the solar tent 400 may be in the fully deployed inverted-V configuration, or in a partially flattened configuration (e.g., between a flat configuration and nonzero angle configuration where the nonzero angle is less than a right angle), or in a flat configuration (e.g., folded, collapsed, etc.). The tray can enable the solar tent 400 to be transported to and/or between multi-terrain environments such as, for example, ungraded ground, rocky landscape, deserts, rooftops, and/or the like.

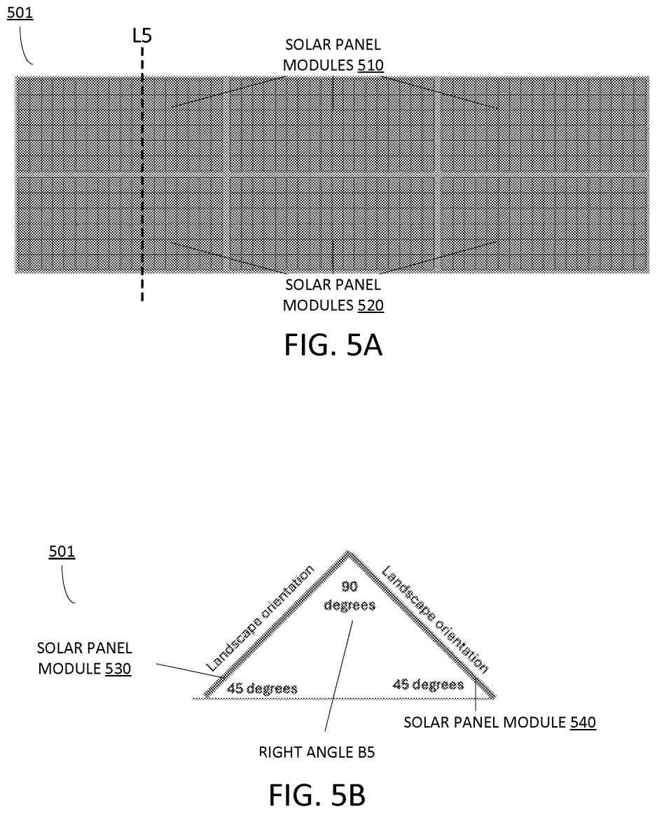

FIG. 5A depicts a plan view of a landscape-landscape solar tent 501, according to an embodiment. Landscape-landscape solar tent 501 includes solar panel modules 510 and solar panel modules 520. Solar panel modules 510 includes three solar panel modules and solar panel modules 520 includes three solar panel modules different from the three solar panel modules of solar panel modules 510. Each solar panel module from solar panel modules 510 and each solar panel module from solar panel modules 520 is oriented in a landscape orientation with respect to an apex of the landscape-landscape solar tent 501, has substantially the same size (e.g., dimensions of length and width) as the remaining solar panel modules and has substantially the same shape (e.g., a rectangle) as the remaining solar panel modules. A set of shorter sidewalls of solar panel modules 510 (e.g., the sidewalls of solar panel modules 510 that are shorter than remaining sidewalls of solar panel modules 510) can be coupled together, for example via adhesives, laminates, and/or fasteners, to form a first row that abuts an apex of landscape-landscape solar tent 501. Similarly, a set of shorter sidewalls of solar panel modules 520 can be coupled together to form a second row that abuts the apex of landscape-landscape solar tent 501. A set of elongate sidewalls of solar panel modules 510 (e.g., the sidewalls of solar panel modules 510 that are longer than remaining sidewalls of solar panel modules 510) can be affixed to a set of elongated sidewalls of solar panel modules 520 to form an array that includes the first row and the second row, the first row being on one side of the apex and the second row being on an opposite side of the apex.

FIG. 5A shows how six solar modules, each being mounted in a “landscape” orientation, with the frames joined (or affixed) at a nonzero (e.g., 90-degree, etc.) angle along the apex of the array can define a solar “tent” (or inverted “V” structure), with solar panel modules 510 and solar panel modules 520 tilted at a substantially same angle (e.g., 45 degrees when the nonzero angle is 90 degrees, etc.) to the horizon on both sides of the apex. In some implementations, solar panel modules 510 and/or solar panel modules 520 can include for example one or more 108-cell 400 W solar panel modules, with dimensions 1.72×1.13 m. Landscape-landscape solar tent 501 does not include a coupler (such as, e.g., coupler 430 of FIG. 4). In some embodiments (e.g., embodiments that have a predefined angle other than 90 degrees), a landscape-landscape solar tent can include a coupler.

In some embodiments, at least one solar panel module from a first row of solar panel modules of a landscape-landscape solar tent and/or at least one solar panel from a second row of solar panel modules of a landscape-landscape solar tent can have a size and/or a shape that is different from a size and/or shape of remaining solar panel modules. For example, in some embodiments, a first solar panel module from a first row of solar panel modules can be smaller than (or larger than) remaining solar panel modules from the first row of solar panel modules and/or smaller than (or larger than) remaining solar panel modules from a second row of solar panel modules.

In some implementations, landscape-landscape solar tent 501 can include one or more types of couplers such as, for example, the coupler 430 of FIG. 4, the couplers 1330 of FIG. 13, or another type of coupler(s) such as hinges disposed along a ridgeline (or apex) of solar tent 1300. In some implementations, landscape-landscape solar tent 501 can include one or more splay limiters such as, for example, the base-attached splay limiter 1430 of FIG. 14, the base-attached splay limiter 1530 of FIG. 15 and/or the ground-attached splay limiter 1630 of FIGS. 16A-16B.

In some implementations, landscape-landscape solar tent 501 can be in contact with a tray (e.g., tray 220A of FIG. 2A, tray 220B of FIG. 2B; not shown in FIG. 3), for example, along portions of a perimeter of landscape-landscape solar tent 501. In some instances, landscape-landscape solar tent 501 can be stored on the tray. In some instances, landscape-landscape solar tent 501 can be transported by the tray between locations. For example, landscape-landscape solar tent 501 can be transported between a shipping container (e.g., container 230 of FIG. 2C) and an installation site by the tray. Instead, or in addition, landscape-landscape solar tent 501 can be transported between a first area of an environment and a second area of an environment by the tray. During transport, the landscape-landscape solar tent 501 may be in the fully deployed inverted-V configuration, or in a partially flattened configuration (e.g., between a flat configuration and a right angle configuration), or in a flat configuration (e.g., folded, collapsed, etc.). The tray can enable the landscape-landscape solar tent 501 to be transported to and/or between multi-terrain environments such as, for example, ungraded ground, rocky landscape, deserts, rooftops, and/or the like.

FIG. 5B depicts a cross-sectional view of the landscape-landscape solar tent 501, having with a right angle. The cross-sectional view of FIG. 5B is taken at cross-section line L5 of FIG. 5A. Landscape-landscape solar tent 501 is an implementation where a right angle exists between a plane of solar panel modules 510 of FIG. 5A and a plane of solar panel modules 520 of FIG. 5A. As shown, solar panel module 530 can be affixed to solar panel module 540 such that a right angle exists between a plane of solar panel module 530 and a plane of solar panel module 540, a 45-degree angle exists between solar panel module 530 and a surface that supports landscape-landscape solar tent 501, and a 45-degree angle exists between solar panel module 540 and the surface that supports landscape-landscape solar tent 501. Landscape-landscape solar tent 501 does not include a coupler (e.g., coupler 430 of FIG. 4). In some embodiments (e.g., embodiments that have a predefined angle other than 90 degrees), a landscape-landscape solar tent can include a coupler.

FIG. 6 depicts a plan view of a portrait solar panel module 610 and a landscape solar panel module 620, according to an embodiment. In some implementations, a shorter sidewall of portrait solar panel module 610 can be affixed to an elongated sidewall of landscape solar panel module 620 to form a portrait-landscape solar tent in an asymmetric “V” configuration, an example of which is shown and described with respect to FIG. 7. In the asymmetric “V” configuration, the landscape solar panel module 620 can be at a relatively steeper angle with respect to a surface that supports the portrait-landscape solar tent and the portrait solar panel module 610 can be at a relatively flatter angle with respect to the surface. In some implementations, the landscape solar panel module 620 can be deployed onto a surface such that an active solar surface of the landscape solar panel module 620 is east-tilted, and the portrait solar panel module 610 can be deployed onto the surface such that an active solar surface of portrait solar panel module 610 is west-tilted.

Such a portrait-landscape solar tent can provide a more efficient battery charging and/or discharging schedule for a battery (not shown) coupled to portrait-landscape solar tent and/or reduce frequency/intensity of battery discharge. For example, battery state of charge is generally lowest in the early morning and battery useful life tends to be reduced by spending time at low state of charge, so by orienting landscape solar panel module 620 relatively steeply tilted toward the east, solar energy can be used to re-charge the battery earlier in the morning. In addition, orienting portrait solar panel module 610 to be relatively flat tilted towards the west can increase power production during a time of day (e.g., mid-afternoon) when power consumption by cooling equipment (e.g., in residences, in offices, in factories, etc.) tends to be relatively high, thus reducing reliance on battery discharge. The asymmetry can be achieved by having the east-facing panels mounted in a landscape orientation while the west-facing panels are mounted in a portrait orientation. When the portrait solar panel module 610 and the landscape solar panel module 620 are set up in a “tent” or inverted-V arrangement (e.g., as shown in FIG. 8A), with the solar panel modules joined to form a 90-degree angle therebetween, the portrait solar panel module 610 can be at a 33-degree angle with respect to the plane of the surface and the landscape solar panel module 620 can be at a 56-degree angle with respect to the plane of the surface. This accomplishes an asymmetric solar “tent” (or inverted-V mounting arrangement) in the absence of additional mounting elements (e.g., coupler(s)) because the frames of the solar panel modules are configured to hold each other in place. In some embodiments (e.g., embodiments that have a predefined angle other than 90 degrees), however, a coupler (e.g., coupler 430 of FIG. 4) can be used.

FIG. 7 depicts a plan view of a portrait-landscape solar tent 700, according to an embodiment. Portrait-landscape solar tent 700 includes portrait solar panel modules 710 (e.g., structurally and/or functionally similar to portrait solar panel module 610 of FIG. 6) and landscape solar panel modules 720 (e.g., structurally and/or functionally similar to landscape solar panel module 620 of FIG. 6). Portrait solar panel modules 710 include five solar panel modules, and landscape solar panel modules 720 include three solar panel modules different from the five solar panel modules of portrait solar panel modules 710. Each solar panel module from portrait solar panel modules 710 is oriented in a portrait orientation with respect to an apex of the portrait-landscape solar tent 700, and each solar panel module from landscape solar panel modules 720 is oriented in a landscape orientation with respect to the apex of the landscape-landscape solar tent 700. Each solar panel module from portrait solar panel modules 710 and each solar panel module from landscape solar panel modules 720 has substantially the same size (e.g., dimensions of length and width) and substantially the same shape (e.g., a rectangle) as the remaining solar panel modules. A set of elongated sidewalls of portrait solar panel modules 710 can be coupled together, for example via adhesives, laminates, and/or fasteners, to form a first row that abuts an apex of portrait-landscape solar tent 700. A set of shorter sidewalls of landscape solar panel modules 720 can be coupled together to form a second row that abuts the apex of portrait-landscape solar tent 700. A set of shorter sidewalls of portrait solar panel modules 710 can be affixed to a set of elongated sidewalls of landscape solar panel modules 720 to form an array that includes the first row and the second row, the first row being on one side of the apex and the second row being on an opposite side of the apex.

In FIG. 7, the plan view and the tilted configuration of the solar panel modules causes landscape solar panel modules 720 to appear narrower than portrait solar panel modules 710, and portrait solar panel modules 710 to appear shorter than landscape solar panel modules 720. In the example of FIG. 7, the cumulative length of the three landscape-oriented solar panel modules appears less than the cumulative width of the five portrait-oriented solar panel modules. The portions along the perimeter of portrait-landscape solar tent 700 are “free” portions in the sense that such portions are not connected to any other solar panel module. The tilt angles of the asymmetric portrait-landscape configuration can be altered or modified. For example, in some embodiments, landscape solar panel modules can be a type different from a type of portrait solar panel modules and can have different dimensions. For example, if landscape solar panel modules are a smaller type of solar panel module, then the portrait solar panel modules can be tilted at a smaller angle relative to the horizontal than is shown, for example, in FIG. 8A, and the landscape solar panel modules can be tilted at a larger angle relative to the horizontal than is shown in, for example, FIG. 8B. Stated similarly, in some embodiments, at least one solar panel module from a first row of solar panel modules of a portrait-landscape solar tent and/or at least one solar panel from a second row of solar panel modules of a portrait-landscape solar tent can have a size and/or a shape that is different from a size and/or shape of remaining solar panel modules. For example, in some embodiments, a first solar panel module from a first row of solar panel modules can be smaller than (or larger than) remaining solar panel modules from the first row of solar panel modules and/or smaller than (or larger than) remaining solar panel modules from a second row of solar panel modules.

In some implementations, portrait-landscape solar tent 700 can include one or more types of couplers such as, for example, the coupler 430 of FIG. 4, the couplers 1330 of FIG. 13, or another type of coupler(s) such as hinges disposed along a ridgeline (or apex) of portrait-landscape solar tent 700. In some implementations, portrait-landscape solar tent 700 can include one or more splay limiters such as, for example, the base-attached splay limiter 1430 of FIG. 14, the base-attached splay limiter 1530 of FIG. 15 and/or the ground-attached splay limiter 1630 of FIGS. 16A-16B.

In some implementations, portrait-landscape solar tent 700 can be in contact with a tray (e.g., tray 220A of FIG. 2A, tray 220B of FIG. 2B; not shown in FIG. 3), for example, along portions of a perimeter of portrait-landscape solar tent 700. In some instances, portrait-landscape solar tent 700 can be stored on the tray. In some instances, portrait-landscape solar tent 700 can be transported by the tray between locations. For example, portrait-landscape solar tent 700 can be transported between a shipping container (e.g., container 230 of FIG. 2C) and an installation site by the tray. Instead, or in addition, portrait-landscape solar tent 700 can be transported between a first area of an environment and a second area of an environment by the tray. During transport, the portrait-landscape solar tent 700 may be in a fully deployed inverted-V configuration, or in a partially flattened configuration (e.g., between a flat configuration and a right angle configuration), or in a flat configuration (e.g., folded, collapsed, etc.). The tray can enable the portrait-landscape solar tent 700 to be transported to and/or between multi-terrain environments such as, for example, ungraded ground, rocky landscape, deserts, rooftops, and/or the like.

FIG. 8A depicts a cross-sectional view of a portrait-landscape solar tent 801 with a right angle. The cross-sectional view of FIG. 8A is taken at cross-section line L7 of FIG. 7. Portrait-landscape solar tent 801 can be structurally and/or functionally similar to the portrait-landscape solar tent 700 of FIG. 7. As shown, portrait solar panel module 810 can be affixed to landscape solar panel module 820 such that a right angle exists between a plane of portrait solar panel module 810 and a plane of landscape solar panel module 820, a 33 degree angle exists between a surface that supports portrait-landscape solar tent 801 and portrait solar panel module 810, and a 56 degree angle exists between the surface that supports portrait-landscape solar tent 801 and landscape solar panel module 820. Portrait-landscape solar tent 801 does not include a coupler (e.g., coupler 430 of FIG. 4). In some embodiments (e.g., embodiments that have a predefined angle other than 90 degrees), a portrait-landscape solar tent can include a coupler (e.g., coupler 430 of FIG. 4).

FIG. 8B depicts a cross-sectional view of a portrait-landscape solar tent 802 with a 135 degree angle. The cross-sectional view of FIG. 8B is taken at cross-section line L7 of FIG. 7. Portrait-landscape solar tent 802 can be structurally and/or functionally similar to the portrait-landscape solar tent 700 of FIG. 7. As shown, portrait solar panel module 830 can be affixed to landscape solar panel module 840 such that a 135 degree angle exists between a plane of portrait solar panel module 830 and a plane of landscape solar panel module 840, an 18 degree angle exists between a surface that supports portrait-landscape solar tent 802 and portrait solar panel module 830, and a 27 degree angle exists between the surface that supports portrait-landscape solar tent 802 and landscape solar panel module 840. In some implementations, portrait-landscape solar tent 802 can include a coupler (e.g., coupler 430 of FIG. 4; not shown in FIG. 8B). As described in connection with FIG. 3, the tilt angles of the portrait-landscape solar tent 802 can be set, or selected, by positioning, for example, a metal angle (or other type of coupler) between the frame of the portrait solar panel module 830 and the landscape solar panel module 840 along the axis (or ridgeline) of portrait-landscape solar tent 802. FIG. 8B shows a configuration where the asymmetric portrait-landscape configuration has a 135-degree predefined angle (rather than 90 degrees), where the west-facing portion of the portrait-landscape solar tent 802 is tilted at 18 degrees and the east-facing portion of the portrait-landscape solar tent 802 is tilted at 27 degrees.

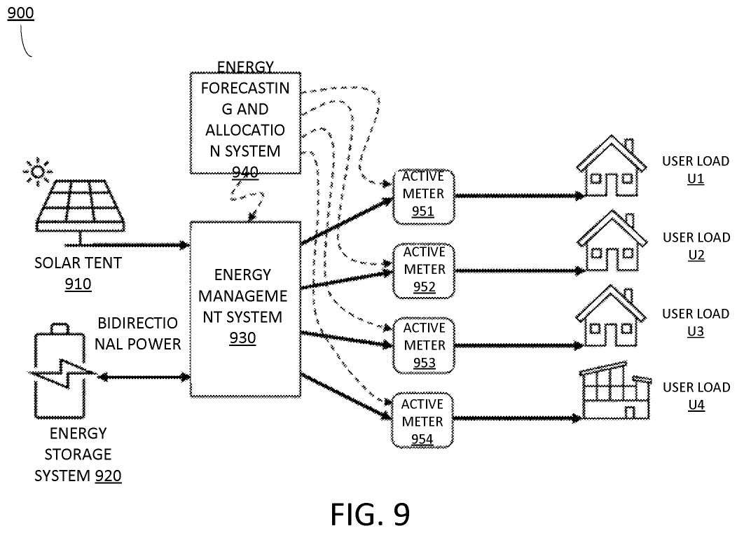

FIG. 9 is a diagram of an example microgrid system for microgrid metering and energy allocation, according to an embodiment. The example microgrid system 900 can be compatible with one or more Firefly embodiments of the present disclosure, and is thus also referred to herein as a Firefly system. The example Firefly system 900 includes solar tents 910 (e.g., structurally and/or functionally similar to any of the solar tent embodiments of FIGS. 2A-8B, 13-16), energy storage system 920, energy management system 930, energy forecasting and allocation system 940, active meter 951, active meter 952, active meter 953, and active meter 954, which can be coupled (e.g., electrically coupled, communicatively coupled, operatively coupled) together.

Energy storage system 920 can be and/or include a battery energy storage system (BESS) including batteries, power conversion systems (e.g., rectifiers, inverters, etc.), and/or battery management systems (e.g., a processor, a memory), for the storage of energy output by solar tents 910 and/or release of energy associated with solar tents 910.

Energy management system 930 can be and/or include an electric bus configured to distribute electric power based on load demand (e.g., based on user load U1, user load U2, user load U3, and/or user load U4 demand). In some implementations, energy management system 930 can include a controller (e.g., a processor and a memory) configured to manage the distribution of electric power to the electric bus and/or from the electric bus based on load demand.

Energy forecasting and allocation system 940 can be and/or include a compute device configured to estimate energy allowance (or demand) for user load U1, user load U2, user load U3, and/or user load U4 based on conditions of energy management system 930 and/or based on parameters of active meter 951, active meter 952, active meter 953, and/or active meter 954 and configured to cause energy management system 930 to distribute energy to user load U1, user load U2, user load U3, and/or user load U4 based on the estimated energy allowance(s). The compute device can include a processor and a memory that stores instructions that when executed by the processor can cause the processor to perform one or more functions described herein.

Active meter 951 can be configured to measure power draw by user load U1. Active meter 952 can be configured to measure power draw by user load U2. Active meter 953 can be configured to measure power draw by user load U3. Active meter 954 can be configured to measure power draw by user load U4. Each of user load U1, user load U2, user load U3, and user load U4 can represent different electrical loads such as, for example, appliances of a residential building, equipment of an industrial building such as a factory, compute resources of a commercial building such as an office, and/or the like. In some implementations, any of user load U1, user load U2, user load U3, and/or user load U4 can be and/or include a Common Control Service (CCS), as described below.

During time periods when power demand exceeds solar power production, some known solar powerplants deliver power to electrical loads using battery energy storage systems (BESS). For example, a known BESS can distribute power to electrical loads when the sun is low or has set, at night, or otherwise during times when power demand exceeds solar power production. Conversely, during time periods when solar power production exceeds energy demand, some known solar powerplants deliver power to a BESS to charge the BESS, in anticipation of a future time period when power demand will exceed solar power production. For example, a known BESS can be charged during a time period associated with peak solar power production. For some known solar arrays, peak power production is often at a middle part of the day. Therefore, some known solar powerplants often have a solar power generating capacity that is sufficiently large to produce enough energy to serve some (and in some instances, all) connected electrical loads over a 24-hour period (plus some additional energy to cover inefficiencies in such systems). Additionally, some known BESS's have capacities that are big enough to serve some (and in some instances, all) the connected electrical loads during time periods when power demand exceeds solar power production.

BESS capacity, however, is expensive. One way to reduce a desired total BESS capacity is to arrange for some electrical loads to operate during peak solar production hours, and for some electrical loads to not operate (and so not consume electricity) during hours being served by the BESS (i.e., when power demand exceeds solar power production).

FIG. 9 depicts an overview of a system that can include any of the Firefly embodiments described herein. In use, the Firefly system 900 serves several electrical loads, each marked as a “user load” and having a uniquely associated “active meter”. The active meters 951-954 can enable the Firefly system 900 to control the power delivered to the user loads U1-U4, for example, to cause distribution of electric power to some user loads from user loads U1-U4 and to limit (or cause restriction of) power to one or more remaining user load(s) from user loads U1-U4. In some instances, it can be desirable to operate specified user loads during time periods when solar power production exceeds power demand, such as Common Control Services (CCS). As used herein, the term “operate” when used with a user load refers to a nonzero power draw by the user load to support a specified function. Examples of CCS can be and/or include desalinating or purifying water, pumping ground water (e.g., for irrigation or to fill a water tower), producing ice or dry ice, producing stored heat, charging mobile batteries (phones, work vehicles) or operating micro-industries (where the economics allow operating during peak sunshine hours and not in the evenings). Firefly system 900 can be configured to distribute power from solar tents 910 to one or more CCS load(s) from user loads U1-U4, during operation of the one or more CCS load(s) and at a time of day that coincides with relatively greater solar power production. Through insertion of additional instances of solar tents 910 to Firefly system 900, Firefly system 900 can be modularly adjusted to increase the size (i.e., the total electrical power capacity) of solar tents 910. For example, more instances of solar tents 910 can be deployed in Firefly system 900 to be coupled to and to produce solar power for CCS loads, relative to the instances of solar tents 910 that are coupled to and produce solar power for the non-CCS loads.

In some instances, Firefly system 900 can distribute power to a user load from user loads U1-U4 according to a power demand profile other than a power demand profile that is desired by a user associated with that user load. For example, Firefly system 900 can determine to distribute less power than is specified by the user-defined power demand profile, independent of the user-defined power demand profile. In some instances, Firefly system 900 can control a power profile for a user load from user loads U1-U4 and can distribute power to that user load according to the system-defined power demand profile. Controlling the power demand profile for one or more user loads can have various downstream benefits.

Because the CCS loads can be under common control with the Firefly system 900, the CCS loads can be operated to reduce the fraction of solar energy that is stored in energy storage system 920. Reducing the amount of solar energy stored in energy storage system 920 can reduce the average resource use, and, thus, economic cost, per unit of power produced for all the user loads (i.e., user load U1, user load U2, user load U3, user load U4, etc.) in the Firefly system 900 (including the CCS loads). In addition, because the size of the set of solar tents from solar tents 910 can be larger for CCS loads relative to the size of the set of solar tents from solar tents 910 for the non-CCS loads, more excess solar energy capacity can exist for CCS loads relative to the non-CCS loads, which reduces the likelihood that the Firefly system 900 will fail to produce enough solar power, on a given day, to serve CCS loads or remaining user loads. Stated similarly, the service reliability to the non-CCS loads can be increased, even while using fewer resources relative to the user load(s) (and thus being able to deliver lower energy costs). FIG. 10 is a graph 1000 depicting an example power profile of a solar tent, according to an embodiment. The solar tent can be and/or include any of the embodiments described herein. In some implementations, the solar tent (e.g., solar tents 910 of FIG. 9) can be included in a Firefly system, such as the Firefly system 900 of FIG. 9. Graph 1000 includes a solid curve that represents the expected solar power production by the solar tent over the course of a 24-hour day, minus the power consumption by the total amount of connected non-CCS loads in the Firefly system. During the mid-part (e.g., between about hour 9 and about hour 12) of the day, the excess power produced by the solar tent can be used to charge a battery (e.g., energy storage system 920 of FIG. 9) in the Firefly system. During the evening and through the night, the loads can be served by the battery. As depicted in graph 1000, the minimum battery state of charge occurs around hour 6, right before the excess solar power production can be used to re-charge the battery.

In some instances, for example either because of higher solar production than is typical for the day, or because of lower consumption by the non-CCS loads than is typical for the day, the excess power is expected to be higher than is typical. Graph 1000 includes a dashed line that represents the expected excess power generated by the solar tent, when excess solar power is expected to be higher than is typical (annotated as a “high surplus day”). In some such instances, the Firefly system can be configured to operate the one or more CCS loads at or with a relatively high power during the day (and, in some instances, even into the early evening), to make productive use of solar power production capacity that would otherwise be curtailed.

In some instances, for example either because of lower solar production than is typical for the day, or higher consumption by non-CCS loads than is typical for the day, the excess power is expected to be lower than is typical. Graph 1000 includes a dotted line that represents the expected excess power generated by the solar tent, when excess power is expected to be lower than is typical (annotated as a “low surplus day”). In some such instances, the Firefly system can be configured to reduce power distribution to one or more CCS loads to a relatively low power, or to reduce power distribution to a substantially zero power, to preserve the available energy and serve non-CCS loads.

Because the CCS loads absorb energy through the course of the year, the solar generating capacity of the Firefly system can be made larger than the solar generating capacity would be in the absence of CCS loads. As a result, in some instances (e.g., on days when there is a low surplus of energy available, if the CCS loads are curtailed), the total production from the larger solar capacity can be directed to serving the non-CCS loads, reducing the likelihood that insufficient solar generation to serve those loads will exist.

In some other instances (e.g., on days when there is a high surplus of energy available), the CCS loads can make productive use of the excess power, reducing the likelihood that solar generation will be curtailed. Because curtailed solar generation represents resources that are not used productively, the CCS loads reduce the risk of having non-productive resources.

Some limitations on curtailing CCS loads can exist. Consider, for example, a CCS load that is pumping water into a water tower. On any given day, if solar energy production is expected to be insufficient, the water pump can be shut off so that the solar energy can be used to power other loads and charge the BESS. Typically, excess water exists in a water tower and a community of users can draw the excess water from the water tower. If, however, a multi-day period exists when solar energy production was insufficient, failing to pump water into the tower could threaten the community's water supply. Because water access carries high priority (e.g., higher than some other consumer loads), an energy management system (e.g., energy management system 930 of FIG. 9) of the Firefly system can be caused to allocate a sufficient (e.g., a minimum) amount of power to the water pump and to restrict power distribution to user loads with a priority lower than pumping water.

Operation of one or more CCS loads can depend on forecasts of energy production and consumer loads, for example over a multi-day look-ahead and/or no less than over the remaining time left in the current day. For example, energy forecasting and allocation system 940 of FIG. 9 can be configured to predict forecasts associated with one or more CCS loads.

In some implementations, the CCS loads can be fully controlled by the Firefly control system. That is, the CCS loads are not merely indirectly controlled, for example by issuing a request to reduce consumption, or by using price signals in accordance with some known techniques used by larger-scale utilities. Furthermore, the CCS loads are also not controlled in a binary way, by, for example, cutting off supply (an “interruptible” load). Rather, the CCS loads can be turned up/down (i.e., receiving more power or less power, respectively) as well as on/off (i.e., receiving nonzero power or zero power, respectively), to match the power demand of the Firefly system and the availability of energy. In some implementations, the Firefly control system can be sole source of control for the CCS loads.

Additional implementation details compatible with one or more embodiments set forth herein can be found, by way of example, in U.S. Pat. No. 12,244,147, titled “Twin-configurable architecture renewable power plant for high capacity factor servicing of controllable loads” and issued on Mar. 4, 2025, in PCT Patent Application No. PCT/US2025/020951, filed Mar. 21, 2025 and titled “Gemini Grid-Connectable Renewable Powerplant Delivering High Capacity Factor to Controllable Loads,” and in U.S. patent application Ser. No. 19/450,338, filed Jan. 15, 2026 and titled “Wind Deflector for Solar Arrays,” the entire contents of each of which are incorporated by reference herein for all purposes.

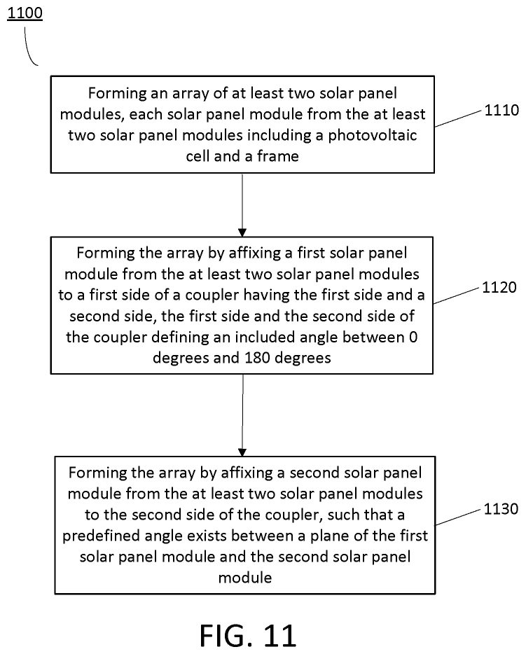

FIG. 11 is a flow diagram of a method 1100 for assembling a solar tent, according to an embodiment. Method 1100 includes, at 1110, forming an array of at least two solar panel modules, each solar panel module from the at least two solar panel modules including a photovoltaic cell and a frame. In some implementations, the array can be a landscape-landscape solar tent (e.g., the landscape-landscape solar tent of FIGS. 5A-5B). In some implementations, the array can be a portrait-landscape solar tent (e.g., the portrait-landscape solar tent(s) of FIGS. 7 and 8A-8B). At 1120, method 1100 includes forming the array by affixing a first solar panel module from the at least two solar panel modules to a first side of a coupler (e.g., coupler 430 of FIG. 4) having the first side and a second side, the first side and the second side of the coupler defining an included angle between 0 degrees and 180 degrees. Affixing can include, for example, fixedly attaching via adhesives, laminates, fasteners, epoxy, brazed joints, clamps, nuts, bolts, rivets, hinges, welds, and/or the like. At 1130, method 1100 includes forming the array by affixing a second solar panel module from the at least two solar panel modules to the second side of the coupler, such that a predefined angle exists between a plane of the first solar panel module and the second solar panel module. Affixing can include, for example, fixedly attaching via adhesives, laminates, fasteners, epoxy, brazed joints, clamps, nuts, bolts, rivets, hinges, welds, and/or the like.

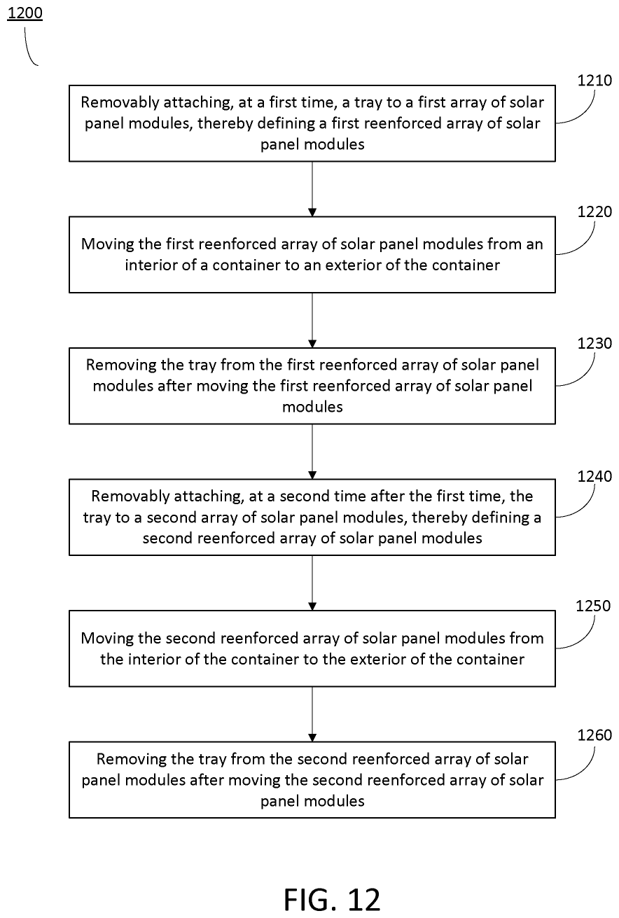

FIG. 12 is a flow diagram of a method 1200 for moving solar panel modules by a reusable tray, according to an embodiment. The reusable tray can be structurally and/or functionally similar to tray 220A of FIG. 2A and/or tray 220B of FIG. 2B, and/or other tray embodiments described herein.

At 1210, method 1200 includes removably attaching, at a first time, a tray to a first array of solar panel modules, thereby defining a first reenforced array of solar panel modules. The first array of solar panel modules can be and/or include an “inverted V” solar tent, a symmetric solar tent, an asymmetric solar tent, a landscape-landscape solar tent, a landscape-portrait solar tent, and/or other types of solar panel assemblies described herein. For example, the first array of solar panel modules can be similar to solar tent 300 of FIG. 3, to landscape-landscape solar tent 501 of FIG. 5A, to portrait-landscape solar tent 700 of FIG. 7, a solar module cluster in a clamshell configuration, etc. Removably attaching can include, for example, sliding the tray between the first array of solar panel modules and a rack (e.g., container rails 232 of FIG. 2) of a container (e.g., container 230) to cause at least a portion of each frame of the first array of solar panel modules to contact the tray. Removably attaching can include, for example, placing the first array of solar panel modules onto the tray to cause at least a portion of each frame of the first array of solar panel modules to contact the tray. Removably attaching can include use of, for example, fasteners, laminates, adhesives, etc., and/or an absence of fasteners, laminates, adhesives, etc. The first reenforced array of solar panel modules can have a rigidity greater than a rigidity of the first array of solar panel modules.

At 1220, method 1200 includes moving the first reenforced array of solar panel modules from an interior of a container to an exterior of the container. The container can be structurally and/or functionally similar to container 230 of FIG. 2C. Moving can include, for example, slidably removing the first reenforced array of solar panel modules from a rack of the container to the exterior of the container. Moving can include, for example, carrying the first reenforced array of solar panel modules from the interior of the container to the exterior of the container. Moving can include, for example, wheeling the first reenforced array of solar panel modules from the interior of the container to the exterior of the container. In some implementations, the container can include a lift, a ramp, and/or the like configured to facilitate transfer of the first reenforced array of solar panel modules from the interior of the container to the exterior of the container. During the moving, the tray can limit (or prevent) a flexure, a twisting, and/or a cracking of the first reenforced array of solar panel modules.

At 1230, method 1200 includes removing the tray from the first reenforced array of solar panel modules after moving the first reenforced array of solar panel modules. Removing the tray can include, for example, uncoupling fastener(s), laminate(s), adhesive(s), etc. to uncouple the tray from the first reenforced array of solar panel modules. Removing the tray can include, for example, slidably removing the tray from beneath the first reenforced array of solar panel modules to cause the first array of solar panel modules to be placed at a specified site. Removing the tray can include, for example, lifting the first array of solar panel modules from the tray to cause the first array of solar panel modules to be placed at a specified site. In some implementations, the specified site can include multi-terrain, as described herein. In some implementations, the specified site can be another container. Removing the tray from the first reenforced array of solar panel modules can cause the tray to be absent of the first array of solar panel modules, to define an “open” tray.

At 1240, method 1200 includes removably attaching, at a second time after the first time, the tray to a second array of solar panel modules, thereby defining a second reenforced array of solar panel modules. Removably attaching can include, for example, sliding the tray between the second array of solar panel modules and a rack (e.g., container rails 232 of FIG. 2) of a container (e.g., container 230) to cause at least a portion of a frame of the second solar panel module to contact the tray. Removably attaching can include, for example, placing the second array of solar panel modules onto the tray to cause at least a portion of a frame of each solar panel module from the second array of solar panel modules to contact the tray. Removably attaching can include use of, for example, fasteners, laminates, adhesives, etc., and/or an absence of fasteners, laminates, adhesives, etc. The second reenforced array of solar panel modules can have a rigidity greater than a rigidity of the second array of solar panel modules.

At 1250, method 1200 includes moving the second reenforced array of solar panel modules from the interior of the container to the exterior of the container. Moving can include, for example, slidably removing the second reenforced array of solar panel modules from a rack of the container to the exterior of the container. Moving can include, for example, carrying the second reenforced array of solar panel modules from the interior of the container to the exterior of the container. Moving can include, for example, wheeling the second reenforced array of solar panel modules from the interior of the container to the exterior of the container. In some implementations, the container can include a lift, a ramp, and/or the like configured to facilitate transfer of the second reenforced array of solar panel modules from the interior of the container to the exterior of the container. During the moving, the tray can limit (or prevent) a flexure, a twisting, and/or a cracking of the second reenforced array of solar panel modules.

At 1260, method 1200 includes removing the tray from the second reenforced array of solar panel modules after moving the second reenforced array of solar panel modules. Removing the tray can include, for example, uncoupling fastener(s), laminate(s), adhesive(s), etc. to uncouple the tray from the second reenforced array of solar panel modules. Removing the tray can include, for example, slidably removing the tray from beneath the second reenforced array of solar panel modules to cause the second array of solar panel modules to be placed at a specified site. Removing the tray can include, for example, lifting the second array of solar panel modules from the tray to cause the second array of solar panel modules to be placed at a specified site. In some implementations, the specified site can include multi-terrain, as described herein. In some implementations, the specified site can be another container. Removing the tray from the second reenforced array of solar panel modules can cause the tray to be absent of the second array of solar panel modules, to define an “open” tray.

In some implementations, method 1200 can include removably attaching, at a third time after the second time, the tray to a third array of solar panel modules, thereby defining a third reenforced array of solar panel modules. In some implementations, method 1200 can include moving the third reenforced array of solar panel modules from a first area of an environment to a second area of the environment. In some implementations, method 1200 can include removing the tray from the third reenforced array of solar panel modules after moving the third reenforced array of solar panel modules.

FIG. 13 depicts a perspective view of an example solar tent 1300 with couplers 1330, according to an embodiment. Solar tent 1300 includes solar panel module 1310 (e.g., structurally and/or functionally similar to solar panel module 310 of FIG. 3), solar panel module 1320 (e.g., structurally and/or functionally similar to solar panel module 320 of FIG. 3), and couplers 1330. Solar panel module 1310 includes frame 1311 (e.g., structurally and/or functionally similar to frame 311 of FIG. 3). Solar panel module 1320 includes frame 1321 (e.g., structurally and/or functionally similar to frame 321 of FIG. 3). Frame 1311 of solar panel module 1310 can be mechanically coupled to frame 1321 of solar panel module 1320 by the couplers 1330.

Couplers 1330 can be configured to mechanically couple (e.g., attach, secure, etc.) solar panel module 1310 to solar panel module 1320. As shown in FIG. 13, the couplers 1330 are configured to couple portions of the sloped frame sides to each other at a fixed angle. Each of the couplers 1330 has an overall inverted-V shape that includes a triangular region and elongate side members that extend partway down the sides of solar panel module 1310 and solar panel module 1320. Alternatively, or in addition, depending on the implementation, couplers 1330 can be and/or include, for example, one or more screws, rivets, clips, adhesives, clamps, and/or the like. As shown, a first coupler from couplers 1330 can be disposed on a first side of solar tent 1300 and a second coupler from couplers 1330 can be disposed on a second side of solar tent 1300 that is opposite to the first side. Each coupler from couplers 1330 can include multiple portions. For example, a first portion of the first coupler can be disposed along a sloped edge of frame 1311, with a length that is less than a length of the sloped edge of frame 1311. Similarly, a second portion of the first coupler can be disposed along a sloped edge of frame 1321, with a length that is less than a length of the sloped edge of frame 1311. In some implementations, the length of the first portion of the first coupler can be substantially the same as the length of the second portion of the first coupler. In some implementations, the length of the first portion of the first coupler can be different from the length of the second portion of the first coupler. The length of either (or both) portion(s) of the first coupler can be, for example, about an eighth of the length of the sloped edge of the respective frame, about a quarter, about a third, about half, and/or the like. A third portion of the first coupler can include a substantially triangular base disposed between the first portion of the first coupler and the second portion of the first coupler. The foregoing description also applies to the second coupler from couplers 1330 that is opposite to the first coupler. In some implementations, couplers 1330 can provide more support for maintaining the configuration of solar tent 1300 relative to another type of coupler that would join solar panel module frames along, for example, a ridgeline (or axis) of a solar tent. In some implementations, couplers 1330 can be used with other embodiments herein, for example, to provide (further) support to solar tent 400, to provide support to landscape-landscape solar tent 501, to provide support to portrait-landscape solar tent 700, etc.

In some implementations, solar tent 1300 can include one or more other types of couplers, for example, the coupler 430 of FIG. 4, or another type of coupler(s) such as hinges disposed along a ridgeline (or apex) of solar tent 1300. In some implementations, solar tent 1300 can include one or more splay limiters, for example, the base-attached splay limiter 1430 of FIG. 14, the base-attached splay limiter 1530 of FIG. 15 and/or the ground-attached splay limiter 1630 of FIGS. 16A-16B.

In some implementations, solar tent 1300 can be in contact with a tray (e.g., tray 220A of FIG. 2A, tray 220B of FIG. 2B; not shown in FIG. 3), for example, along portions of a perimeter of solar tent 1300. In some instances, solar tent 1300 can be stored on the tray. In some instances, solar tent 1300 can be transported by the tray between locations (in a deployed configuration (e.g., inverted-V), or optionally, in a folded, collapsed, or disassembled condition). For example, solar tent 1300 can be transported between a shipping container (e.g., container 230 of FIG. 2C) and an installation site by the tray. Instead, or in addition, solar tent 1300 can be transported between a first area of an environment and a second area of an environment by the tray. The tray can enable the solar tent 1300 to be transported to and/or between multi-terrain environments such as, for example, ungraded ground, rocky landscape, deserts, rooftops, and/or the like.

FIG. 14 depicts a perspective view of an example solar tent 1400 with a base-attached splay limiter, according to an embodiment. Solar tent 1400 includes solar panel module 1410 (e.g., structurally and/or functionally similar to solar panel module 310 of FIG. 3), solar panel module 1420 (e.g., structurally and/or functionally similar to solar panel module 320 of FIG. 3), and base-attached splay limiter 1430 (or simply, splay limiter 1430). Solar panel module 1410 includes frame 1411 (e.g., structurally and/or functionally similar to frame 311 of FIG. 3). Solar panel module 1420 includes frame 1421 (e.g., structurally and/or functionally similar to frame 321 of FIG. 3). Frame 1411 of solar panel module 1410 can be mechanically coupled to frame 1421 of solar panel module 1420 by splay limiter 1430.

Splay limiter 1430 can be configured to limit splaying of solar tent 1400 that could otherwise cause a ridgeline (or axis) of solar tent 1400 to collapse. Splay limiter 1430 can reduce (or eliminate) the bending moment at the apex of solar tent 1400. Splay limiter 1430 can be and/or include a cable, rope, cord, bar or any other rigid, hinged, non-rigid and/or flexible elongate member, fixedly coupled (e.g., permanently attached) or removably coupled to each of frame 1411 and frame 1421. Splay limiter 1430 can be fixedly coupled to frame 1411 and frame 1421 by, for example, making an eye (not shown) at each end of the cable (for example, by passing the cable around a thimble (not shown) and swaging it back on itself), then passing a bolt (not shown) through the thimble and either directly into frame 1411 (or frame 1421) or, alternatively, into a clamp coupled (e.g., affixed) to the frame 1411 (or frame 1421) (so as to avoid piercing frame 1411 and/or frame 1421). In some implementations, splay limiter 1430 can be installed onto solar tent 1400 in the factory rather than the field. Alternatively or in addition, in some implementations, solar tent 1400 can be or include a cable and/or rigid rod that is clipped or clamped to the solar panel modules in the field, e.g., during a time when the clamshell module cluster is deployed onto a surface. In such instances, it may be useful if the deployment team has something to support the apex of the tray while the cross-tray member is fitted.

Splay limiter 1430 includes end portion 1432 and end portion 1434. The sloped edge of frame 1411 includes corner portion 1412 and midpoint portion 1414. The sloped edge of frame 1421 includes corner portion 1422 and midpoint portion 1424. Splay limiter 1430 can be disposed at a first side of solar tent 1400 between a sloped edge of frame 1411 and a sloped edge of frame 1421. End portion 1432 of splay limiter 1430 can be mechanically coupled to midpoint portion 1414 of frame 1411. Relatedly, end portion 1434 of splay limiter 1430 can be mechanically coupled to midpoint portion 1424 of frame 1421. For example, splay limiter 1430 can be fastened to each of the solar panel modules at a location that is about half-way along its length (as shown, half-way along the sloped edge of each solar panel module). Splay limiter 1430 could be fastened to each of the solar panel modules at lower end portions of frame 1411 and/or lower end portions of frame 1421 or at any reasonable point along sloped edges of frame 1411 and/or sloped edges of frame 1421, but as splay limiter 1430 is moved closer to the lower end (e.g., nearer the corner portion 1412 and/or corner portion 1422) of each solar panel module it increases the likelihood that splay limiter 1430 will interfere with the ground on, for example, an uneven surface; and as it is moved closer to the apex line (e.g., away from corner portion 1412 and/or corner portion 1422) between the solar panel modules, it increases both the tension load on splay limiter 1430 (countered by greater strength of the splay limiter) and both the tension load and bending moment on the attachment point on each solar panel module (countered by greater material strength for the solar module frame). An attachment point near the mid-point (e.g., midpoint portion 1414 and/or midpoint portion 1424) of the solar module frame (e.g., defined by frame 1411 and frame 1421) is likely to be desirable in most cases.

Although obscured by the perspective view of FIG. 14, a second instance of splay limiter 1430 can be disposed at a second side of solar tent 1400 that is opposite to the first side of solar tent 1400, for example, between an opposite sloped edge of frame 1411 and an opposite sloped edge of frame 1421.

In some implementations, solar tent 1400 can include one or more couplers, for example, the coupler 430 of FIG. 4, the couplers 1330 of FIG. 13, or another type of coupler(s) such as hinges disposed along a ridgeline (or apex) of solar tent 1400. In some implementations, solar tent 1400 can include one or more other types of splay limiters, for example, the base-attached splay limiter 1530 of FIG. 15 and/or the ground-attached splay limiter 1630 of FIGS. 16A-16B.

In some implementations, solar tent 1400 can be in contact with a tray (e.g., tray 220A of FIG. 2A, tray 220B of FIG. 2B; not shown in FIG. 3), for example, along portions of a perimeter of solar tent 1400. In some instances, solar tent 1400 can be stored on the tray. In some instances, solar tent 1400 can be transported by the tray between locations. For example, solar tent 1400 can be transported between a shipping container (e.g., container 230 of FIG. 2C) and an installation site by the tray. Instead, or in addition, solar tent 1400 can be transported between a first area of an environment and a second area of an environment by the tray. The tray can enable the solar tent 1400 to be transported to and/or between multi-terrain environments such as, for example, ungraded ground, rocky landscape, deserts, rooftops, and/or the like.

FIG. 15 depicts a perspective view of an example solar tent 1500 with another type of base-attached splay limiter, according to another embodiment. Solar tent 1500 includes solar panel module 1510 (e.g., structurally and/or functionally similar to solar panel module 310 of FIG. 3), solar panel module 1520 (e.g., structurally and/or functionally similar to solar panel module 320 of FIG. 3), and base-attached splay limiter 1530 (or simply, splay limiter 1530). Solar panel module 1510 includes frame 1511 (e.g., structurally and/or functionally similar to frame 311 of FIG. 3). Solar panel module 1520 includes frame 1521 (e.g., structurally and/or functionally similar to frame 321 of FIG. 3). Frame 1511 of solar panel module 1510 can be mechanically coupled to frame 1521 of solar panel module 1520 by splay limiter 1530.

Splay limiter 1530 can be disposed at a first side of solar tent 1500 between a sloped edge of frame 1511 and a sloped edge of frame 1521. The sloped edge of frame 1511 includes corner portion 1512 and midpoint portion 1514. The sloped edge of frame 1521 includes corner portion 1522 and midpoint portion 1524. End portion 1532 of splay limiter 1530 can be mechanically coupled to midpoint portion 1514 of frame 1511. Relatedly, end portion 1534 of splay limiter 1530 can be mechanically coupled to midpoint portion 1524 of frame 1521. For example, splay limiter 1530 can be fastened to each of the solar panel modules at half-way along its length (as shown, half-way along the sloped edge of each solar panel module). Similarly to the splay limiter 1430 of FIG. 14, splay limiter 1530 could be fastened to each of the solar panel modules at lower end portions of frame 1511 (e.g., nearer corner portion 1512) and/or lower end portions of frame 1521 (e.g., nearer corner portion 1522) or at any reasonable point along sloped edges of frame 1511 and/or sloped edges of frame 1521.

Splay limiter 1530 can be configured to limit splaying of solar tent 1500 that could otherwise cause a ridgeline (or axis) of solar tent 1500 to collapse. Splay limiter 1530 can reduce (or eliminate) the bending moment at the apex of solar tent 1500. Splay limiter 1530 can be and/or include a hinged rod having hinges 1536 that is fixedly coupled (e.g., permanently attached) to each of a sloped edge of frame 1511 and a sloped edge of frame 1521. Splay limiter 1530 can be fixedly coupled to each of the sloped edge of frame 1511 and the sloped edge of frame 1521 via, for example, a first hinge from hinges 1536 at end portion 1532, a second hinge from hinges 1536 at end portion 1534, and a third hinge from hinges 1536 at a midpoint portion of splay limiter 1530. In FIG. 15, the hinged rod is substantially parallel, causing an absence of a small angle between the two sides of base-attached splay limiter 1530.

In some implementations, solar tent 1500 can include one or more couplers such as, for example, the coupler 430 of FIG. 4, the couplers 1330 of FIG. 13, or another type of coupler(s) such as hinges disposed along a ridgeline (or apex) of solar tent 1500. In some implementations, solar tent 1500 can include one or more other types of splay limiters such as, for example, the base-attached splay limiter 1430 of FIG. 14 and/or the ground-attached splay limiter 1630 of FIGS. 16A-16B.

In some implementations, solar tent 1500 can be in contact with a tray (e.g., tray 220A of FIG. 2A, tray 220B of FIG. 2B; not shown in FIG. 3), for example, along portions of a perimeter of solar tent 1500. In some instances, solar tent 1500 can be stored on the tray. In some instances, solar tent 1500 can be transported by the tray between locations. For example, solar tent 1500 can be transported between a shipping container (e.g., container 230 of FIG. 2C) and an installation site by the tray. Instead, or in addition, solar tent 1500 can be transported between a first area of an environment and a second area of an environment by the tray. During transport, the solar tent 1500 may be in a fully deployed inverted-V configuration (e.g., as shown in FIG. 15), or in a partially flattened configuration (e.g., between a flat configuration and a fully deployed configuration), or in a flat configuration (e.g., folded, collapsed, etc.). The tray can enable the solar tent 1500 to be transported to and/or between multi-terrain environments such as, for example, ungraded ground, rocky landscape, deserts, rooftops, and/or the like.

FIG. 16A depicts a perspective view of an example solar tent 1600 with ground-attached splay limiters, according to an embodiment. Solar tent 1600 includes solar panel module 1610 (e.g., structurally and/or functionally similar to solar panel module 310 of FIG. 3), solar panel module 1620 (e.g., structurally and/or functionally similar to solar panel module 320 of FIG. 3), and ground-attached splay limiters 1630 (or simply, splay limiters 1630). Solar panel module 1610 includes frame 1611 (e.g., structurally and/or functionally similar to frame 311 of FIG. 3). Frame 1611 includes corner portion 1612 and corner portion 1614. Solar panel module 1620 includes frame 1621 (e.g., structurally and/or functionally similar to frame 321 of FIG. 3). Frame 1621 includes corner portion 1622 and corner portion 1624. As shown, each of the four ground-attached splay limiters 1630 can be disposed with a different corner portion from corner portion 1612, corner portion 1614, corner portion 1622, and corner portion 1624.

Ground-attached splay limiters 1630 can be configured to limit splaying of solar tent 1600 that could otherwise cause a ridgeline (or axis) of solar tent 1600 to collapse. Splay limiter 1630 can reduce (or eliminate) the bending moment at the apex of solar tent 1600. Each of the ground-attached splay limiters 1630 includes a ground-anchored foot 1632 and a retaining clamp 1634. As shown, for example, ground-anchored foot 1632 of the front-right ground-attached splay limiter can be disposed between corner portion 1622 and a surface that supports solar tent 1600. Retaining clamp 1634 can mechanically couple ground-anchored foot 1632 to corner portion 1622 of frame 1621.

In some implementations, solar tent 1600 can include one or more couplers such as, for example, the coupler 430 of FIG. 4, the couplers 1330 of FIG. 13, or another type of coupler(s) such as hinges disposed along a ridgeline (or apex) of solar tent 1500. In some implementations, solar tent 1600 can include one or more other types of splay limiters such as, for example, the base-attached splay limiter 1430 of FIG. 14 and/or the base-attached splay limiter 1530 of FIG. 15.

In some implementations, solar tent 1600 can be in contact with a tray (e.g., tray 220A of FIG. 2A, tray 220B of FIG. 2B; not shown in FIG. 3), for example, along portions of a perimeter of solar tent 1600. In some instances, solar tent 1600 can be stored on the tray. In some instances, solar tent 1600 can be transported by the tray between locations. For example, solar tent 1600 can be transported between a shipping container (e.g., container 230 of FIG. 2C) and an installation site by the tray. Instead, or in addition, solar tent 1600 can be transported between a first area of an environment and a second area of an environment by the tray. During transport, the solar tent 1600 may be in a fully deployed inverted-V configuration, or in a partially flattened configuration (e.g., between a flat configuration and a fully deployed configuration), or in a flat configuration (e.g., folded, collapsed, etc.). The tray can enable the solar tent 1600 to be transported to and/or between multi-terrain environments such as, for example, ungraded ground, rocky landscape, deserts, rooftops, and/or the like.

FIG. 16B depicts the ground-attached splay limiter of FIG. 16A, according to an embodiment. As shown in FIG. 16B, a retaining bolt 1636 can fixedly couple ground-anchored foot 1632 to retaining clamp 1634. In some embodiments, a type of coupler other than or in addition to retaining bolt 1636 can fixedly couple a ground-anchored foot to a retaining clamp to form a ground-attached splay limiter. Ground-anchored foot 1632 can have a sidewall portion configured to contact a sidewall of a frame (e.g., frame 1621 of FIG. 16A, etc.) and ground anchor 1633 configured to fix the ground-anchored foot 1632 in place relative to ground. Accordingly, ground-anchored foot 1632 can reduce (or prevent) splaying of the frame. Retaining clamp 1634 can have a sloped portion configured to clamp to a sloped edge of a frame (e.g., frame 1621 of FIG. 16A, etc.). Accordingly, retaining clamp 1634 can be a support that rigidly couples the ground-anchored foot 1632 to a frame (e.g., frame 1621 of FIG. 16A, etc.).

A ground-attached splay limiter can be installed in various ways. With reference to ground-attached splay limiter 1630, for example, ground-anchored foot 1632 can be anchored to the ground, a frame can then be mounted onto the ground-anchored foot 1632, and finally the retaining clamp 1634 can be fixedly coupled to ground-anchored foot 1632 to rigidly couple the frame to the ground-anchored foot 1632. In some embodiments, a ground-attached splay limiter can include a retaining clamp with a foot portion that, rather than facing and being disposed under a frame, faces away from a frame to be capable of being anchored to the ground without affixing the retaining clamp to a separate foot in the field. For example, such a retaining clamp can be clamped to a frame prior to a deployment phase (e.g., during a manufacturing phase), and, during a deployment phase, can be anchored to the ground without a coupling between that retaining clamp and a separate foot during the deployment phase.

In some embodiments, an apparatus comprises: a solar panel assembly including a plurality of solar panel modules, each solar panel module from the plurality of solar panel modules (1) including a solar panel from a plurality of solar panels and a frame from a plurality of frames, and (2) mechanically coupled to at least one other solar panel module from the plurality of solar panel modules; and a tray sized and configured to removably contact a portion of a perimeter of each solar panel module from at least a subset of solar panel modules from the plurality of solar panel modules, the tray configured to limit a flexure of the solar panel assembly when the solar panel assembly is in contact with the tray.

In some such implementations, each solar panel module from the plurality of solar panel modules is mechanically coupled to the at least one other solar panel module from the plurality of solar panel modules using an adhesive.

In some such implementations, a portion of the frame of each solar panel module from the at least a subset of solar panel modules contacts the tray when the solar panel assembly is in contact with the tray.

In some such implementations, the tray is further configured to prevent a twisting of the solar panel assembly when the solar panel assembly is in contact with the tray.

In some such implementations, the tray is further configured to at least one of: (1) add rigidity to the solar panel assembly, or (2) prevent a cracking of the plurality of solar panels when the solar panel assembly is in contact with the tray and when the solar panel assembly and the tray are collectively moved.

In some such implementations, the tray comprises a body and a plurality of wheels, the body being disposed between the plurality of wheels and the solar panel assembly when the tray removably contacts the portion of the perimeter of each solar panel module from the at least a subset of solar panel modules from the plurality of solar panel modules.

In some such implementations, the frame of each solar panel module from the plurality of solar panel modules is configured to be slidably inserted into, removably positioned on a rack of, and slidably removed from, a shipping container.

In some such implementations, each solar panel module from the plurality of solar panel modules is mechanically coupled to the at least one other solar panel module from the plurality of solar panel modules using at least one of a clamp, a nut and bolt, a rivet, or a metallic bond.

In some such implementations, for each solar panel module from the plurality of solar panel modules, that solar panel module is mechanically coupled to the at least one other solar panel module from the plurality of solar panel modules via an abutment of the frame of that solar panel module to the frame of each other solar panel from the at least one other solar panel module from the plurality of solar panel modules.

In some such implementations, for at least one solar panel module from the plurality of solar panel modules, that solar panel module is hingedly attached to the associated at least one other solar panel module from the plurality of solar panel modules.

In some such implementations, the solar panel assembly is a first solar panel assembly, and the tray is configured to remove the first solar panel assembly from a shipping container at a first time, and to remove a second solar panel assembly different from the first solar panel assembly from the shipping container at a second time after the first time.

In some embodiments, a method comprises: removably attaching, at a first time, a tray to a first array of solar panel modules, thereby defining a first reenforced array of solar panel modules; moving the first reenforced array of solar panel modules from an interior of a container to an exterior of the container; removing the tray from the first reenforced array of solar panel modules after moving the first reenforced array of solar panel modules; removably attaching, at a second time after the first time, the tray to a second array of solar panel modules, thereby defining a second reenforced array of solar panel modules; moving the second reenforced array of solar panel modules from the interior of the container to the exterior of the container; and removing the tray from the second reenforced array of solar panel modules after moving the second reenforced array of solar panel modules.

In some such implementations, each solar panel module from the first array of solar panel modules includes a solar panel from a plurality of solar panels and a frame from a plurality of frames, each solar panel module from the first array of solar panel modules mechanically coupled to at least one other solar panel module from the first array of solar panel modules.

In some such implementations, each solar panel module from the first array of solar panel modules includes a solar panel from a plurality of solar panels and a frame from a plurality of frames, each solar panel module from the first array of solar panel modules mechanically coupled to at least one other solar panel module from the first array of solar panel modules; and each solar panel module from the second array of solar panel modules includes a solar panel from a plurality of solar panels and a frame from a plurality of frames, each solar panel module from the second array of solar panel modules mechanically coupled to at least one other solar panel module from the second array of solar panel modules.

In some such implementations, each solar panel module from the first array of solar panel modules includes a solar panel from a plurality of solar panels and a frame from a plurality of frames, and a portion of the frame of each solar panel module from at least a subset of solar panel modules from the first array of solar panel modules contacts the tray when the first array of solar panel modules is in contact with the tray.

In some such implementations, the tray is configured to prevent at least one of a flexure, a twisting, or a cracking of the first array of solar panel modules when the first array of solar panel modules is in contact with the tray.

In some such implementations, each solar panel module from the first array of solar panel modules includes a solar panel from a plurality of solar panels and a frame from a plurality of frames, each solar panel module from the first array of solar panel modules being mechanically coupled to at least one other solar panel module from the first array of solar panel modules using at least one of a clamp, a nut and bolt, a rivet, or a metallic bond.

In some such implementations, each solar panel module from the first array of solar panel modules includes a solar panel from a plurality of solar panels and a frame from a plurality of frames, each solar panel module from the first array of solar panel modules being mechanically coupled to at least one other solar panel module from the first array of solar panel modules using an adhesive.

In some such implementations, for each solar panel module from the first array of solar panel modules, that solar panel module is mechanically coupled to at least one other solar panel module from the first array of solar panel modules via an abutment of a frame of that solar panel module to a frame of the at least one other solar panel module from the first array of solar panel modules.

In some such implementations, for at least one solar panel module from the first array of solar panel modules, that solar panel module is hingedly attached to at least one other solar panel module from the first array of solar panel modules.

In some such implementations, for each solar panel module from the first array of solar panel modules, that solar panel module is attached to at least one other solar panel module from the first array of solar panel modules via a fastener such that when that solar panel module is rotated relative to the at least one other solar panel module from the first array of solar panel modules, that solar panel module and the at least one other solar panel module lock into place in a configuration having a predefined angle.

All definitions, as defined and used herein, should be understood to control over dictionary definitions, definitions in documents incorporated by reference, and/or ordinary meanings of the defined terms.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

As used herein, the term “substantially” refers to an equivalence that accounts for minor variations from an absolute value or absolute state. In some instances, minor variations can be attributable to manufacturing tolerances or expected fluctuations in component performance or state. For example, a first plane that is substantially parallel to a second plane is understood to mean that the first plane is 99.9% parallel, 99.5% parallel, or 99.2% parallel to the second plane. As another example, a first plane that is substantially orthogonal to a second plane is understood to mean that the first plane is 99.9% orthogonal, 99.5% orthogonal, or 99.2% orthogonal to the second plane. As yet another example, a first angle (or other metric) that is substantially the same as a second angle (or other metric) is understood to mean that the first angle is 99.9% equivalent, 99.5% equivalent, or 99.2% equivalent to the second angle. As yet another example, a substantially 90-degree (or other valued) angle refers to a 90-degree (or other valued) angle that permits deviations by no more than a small tolerance (e.g., 0.0001 degrees, 0.001 degrees, 0.01 degrees, 0.1 degrees). As yet another example, a plane that is substantially flat refers to a plane that permits deviations in flatness by no more than a small tolerance (e.g., 0.001%, 0.01%, 0.1%, 1%).

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus, comprising:
a solar panel assembly including a plurality of solar panel modules, each solar panel module from the plurality of solar panel modules (1) including a solar panel from a plurality of solar panels and a frame from a plurality of frames, and (2) mechanically coupled to at least one other solar panel module from the plurality of solar panel modules; and
a tray sized and configured to removably contact a portion of a perimeter of each solar panel module from at least a subset of solar panel modules from the plurality of solar panel modules, the tray configured to limit a flexure of the solar panel assembly when the solar panel assembly is in contact with the tray.

2. The apparatus of claim 1, wherein each solar panel module from the plurality of solar panel modules is mechanically coupled to the at least one other solar panel module from the plurality of solar panel modules using an adhesive.

3. The apparatus of claim 1, wherein a portion of the frame of each solar panel module from the at least a subset of solar panel modules contacts the tray when the solar panel assembly is in contact with the tray.

4. The apparatus of claim 1, wherein the tray is further configured to prevent a twisting of the solar panel assembly when the solar panel assembly is in contact with the tray.

5. The apparatus of claim 1, wherein the tray is further configured to at least one of: (1) add rigidity to the solar panel assembly, or (2) prevent a cracking of the plurality of solar panels when the solar panel assembly is in contact with the tray and when the solar panel assembly and the tray are collectively moved.

6. The apparatus of claim 1, wherein the tray comprises a body and a plurality of wheels, the body being disposed between the plurality of wheels and the solar panel assembly when the tray removably contacts the portion of the perimeter of each solar panel module from the at least a subset of solar panel modules from the plurality of solar panel modules.

7. The apparatus of claim 1, wherein the frame of each solar panel module from the plurality of solar panel modules is configured to be slidably inserted into, removably positioned on a rack of, and slidably removed from, a shipping container.

8. The apparatus of claim 1, wherein each solar panel module from the plurality of solar panel modules is mechanically coupled to the at least one other solar panel module from the plurality of solar panel modules using at least one of a clamp, a nut and bolt, a rivet, or a metallic bond.

9. The apparatus of claim 1, wherein, for each solar panel module from the plurality of solar panel modules, that solar panel module is mechanically coupled to the at least one other solar panel module from the plurality of solar panel modules via an abutment of the frame of that solar panel module to the frame of each other solar panel from the at least one other solar panel module from the plurality of solar panel modules.

10. The apparatus of claim 1, wherein, for at least one solar panel module from the plurality of solar panel modules, that solar panel module is hingedly attached to the associated at least one other solar panel module from the plurality of solar panel modules.

11. The apparatus of claim 1, wherein the solar panel assembly is a first solar panel assembly, and the tray is configured to remove the first solar panel assembly from a shipping container at a first time, and to remove a second solar panel assembly different from the first solar panel assembly from the shipping container at a second time after the first time.

12. A method, comprising:
removably attaching, at a first time, a tray to a first array of solar panel modules, thereby defining a first reenforced array of solar panel modules;
moving the first reenforced array of solar panel modules from an interior of a container to an exterior of the container;
removing the tray from the first reenforced array of solar panel modules after moving the first reenforced array of solar panel modules;
removably attaching, at a second time after the first time, the tray to a second solar panel module, thereby defining a second reenforced array of solar panel modules;
moving the second reenforced array of solar panel modules from the interior of the container to the exterior of the container; and
removing the tray from the second reenforced array of solar panel modules after moving the second reenforced array of solar panel modules.

13. The method of claim 12, wherein each solar panel module from the first array of solar panel modules includes a solar panel from a plurality of solar panels and a frame from a plurality of frames, each solar panel module from the first array of solar panel modules mechanically coupled to at least one other solar panel module from the first array of solar panel modules.

14. The method of claim 12, wherein:
each solar panel module from the first array of solar panel modules includes a solar panel from a plurality of solar panels and a frame from a plurality of frames, each solar panel module from the first array of solar panel modules mechanically coupled to at least one other solar panel module from the first array of solar panel modules; and
each solar panel module from the second array of solar panel modules includes a solar panel from a plurality of solar panels and a frame from a plurality of frames, each solar panel module from the second array of solar panel modules mechanically coupled to at least one other solar panel module from the second array of solar panel modules.

15. The method of claim 12, wherein each solar panel module from the first array of solar panel modules includes a solar panel from a plurality of solar panels and a frame from a plurality of frames, and a portion of the frame of each solar panel module from at least a subset of solar panel modules from the first array of solar panel modules contacts the tray when the first array of solar panel modules is in contact with the tray.

16. The method of claim 12, wherein the tray is configured to prevent at least one of a flexure, a twisting, or a cracking of the first array of solar panel modules when the first array of solar panel modules is in contact with the tray.

17. The method of claim 12, wherein each solar panel module from the first array of solar panel modules includes a solar panel from a plurality of solar panels and a frame from a plurality of frames, each solar panel module from the first array of solar panel modules being mechanically coupled to at least one other solar panel module from the first array of solar panel modules using at least one of a clamp, a nut and bolt, a rivet, or a metallic bond.

18. The method of claim 12, wherein each solar panel module from the first array of solar panel modules includes a solar panel from a plurality of solar panels and a frame from a plurality of frames, each solar panel module from the first array of solar panel modules being mechanically coupled to at least one other solar panel module from the first array of solar panel modules using an adhesive.

19. The method of claim 12, wherein, for each solar panel module from the first array of solar panel modules, that solar panel module is mechanically coupled to at least one other solar panel module from the first array of solar panel modules via an abutment of a frame of that solar panel module to a frame of the at least one other solar panel module from the first array of solar panel modules.

20. The method of claim 12, wherein, for at least one solar panel module from the first array of solar panel modules, that solar panel module is hingedly attached to at least one other solar panel module from the first array of solar panel modules.

21. The method of claim 12, wherein, for each solar panel module from the first array of solar panel modules, that solar panel module is attached to at least one other solar panel module from the first array of solar panel modules via a fastener such that when that solar panel module is rotated relative to the at least one other solar panel module from the first array of solar panel modules, that solar panel module and the at least one other solar panel module lock into place in a configuration having a predefined angle.
